(19) United States
(12) Patent Application Publication
(10) Pub. No.: US 2009/0171741 A1
(43) Pub. Date: Jul. 2, 2009

(54) BSM Problem Analysis Programmable Apparatus

(75) Inventors: Ellis E. Bishop, Austin, TX (US); Randy S. Johnson, O'Fallon, MO (US); Tedrick N. Northway, Wood River, IL (US); Norman J. Peterson, Austin, TX (US); Paul D. Peterson, Round Rock, TX (US); H. William Rinckel, Prospect, CT (US)

Correspondence Address: DUKE W. YEE, YEE AND ASSOCIATES, P.C., P.O. BOX 802333, DALLAS, TX, 75380, US

(73) Assignee: INTERNATIONAL BUSINESS MACHINES CORPORATION, Armonk, NY (US)

(21) Appl. No.: 12/372,669

(22) Filed: Feb. 17, 2009

Related U.S. Application Data
(63) Continuation-in-part of application No. 11/189,913, filed on Jul. 26, 2005, now Pat. No. 7,493,326.

(51) Int. Cl. G06Q 10/00; G06F 11/07

(52) U.S. Cl. 705/8; 705/7; 714/2; 714/E11.023

(57) ABSTRACT

A system (apparatus), computer implemented method, and program product for analyzing a problem in a distributed processing business system used to provide a service comprises identifying the problem; preparing for an audit; performing the audit; reviewing the audit; developing an action plan; developing an execution plan; deploying a solution in accordance with the execution plan; monitoring the deployed solution; and recording lessons learned. Alternatively, the system (apparatus), computer implemented method, and program product may be applied to evaluate the capacity of a distributed processing business system to provide a prospective service. In this alternative embodiment, the system (apparatus), computer implemented method, and program product comprises identifying the problem; preparing for an audit; performing the audit; reviewing the audit; preparing a rating table; populating the rating table with results from the audit; calculating a service rating based upon the results entered in the rating table; and presenting the service rating to management.

### CROSS-REFERENCE TO RELATED APPLICATIONS

This application is a continuation-in-part of application Ser. No. 11/189,913, filed Jul. 26, 2005.

### BACKGROUND OF THE INVENTION

1. Field of the Invention

The present invention includes subject matter drawn to a system and programmable apparatus for analyzing the delivery of business systems management services.

2. Description of the Related Art

Today's distributed processing business systems often include resources from multiple vendors and platforms connected through large open networks. To understand the status of a particular resource in a modern business system is to comprehend only a small part of the picture. To truly maximize the business value of business system investments, a business also must see how each resource affects the applications and business processes it supports.

Many resources in a distributed processing system are interdependent, and businesses must be able to demonstrate and leverage linkages between business systems and business processes. These links are critical to being agile, allowing business processes to drive technology decisions and priorities. Without these links, a business has virtually no way of knowing how an individual resource, or group of resources impact a given business process. If, for example, a particular Web server were to go down, a business would not be able to identify specific business processes that would be adversely affected.

Business systems management (BSM), also sometimes referred to as “business service management,” is an evolving technology that can be employed to help a business understand how the performance and availability of technology resources affect the applications, processes, and services that power a business. BSM technologies help a business prioritize technology resources that carry the highest business values, not just the latest problem that crops up. Revenue-generating activities, such as order processing—rather than internal processes, such as a human resources system—are prioritized in the event of a problem or outage.

BSM software products, such as TIVOLI Business Systems Manager from International Business Machines Corporation, enable a business to align daily operations management with business priorities, set and meet service level commitments, implement predictive management capabilities across business systems infrastructure, and generate reports to keep executives and business units that use the business's services informed and productive.

Problem management techniques, though, have not kept pace with the rest of BSM technology. Unlike the modern business systems just described, early business systems were based upon a relatively simple mainframe design that generally comprised a single mainframe computer connected to user terminals through a closed network. Problems in these early business systems could be detected simply by monitoring the network and the mainframe computer for undesired or unexpected performance. Likewise, any such problems could be resolved by repairing or adjusting one of these two components.

Clearly, such limited problem management techniques are inadequate for analyzing problems in a modern, complex business system in which the links between business systems and business processes are so critical. To effectively resolve problems in a modern business system, a business first must be able to identify the source of the problem—which itself may be a daunting task. The source of the problem could be a technology resource, a business process, a link between a resource and a process, or any combination thereof. Problem identification, though, is not the only new hurdle for modern business systems management. A single change to a single component of a business system can have widespread effects on many interdependent components. Sometimes, such changes can produce unexpected and undesired results. Thus, once a problem has been identified, a business also must be able to evaluate possible solutions to determine the effect of the solution on the business system as a whole.

Accordingly, there currently is a need for a problem management system that can identify a problem in a modern business system and evaluate the effect of a solution on the business system as a whole.

### BRIEF SUMMARY OF THE INVENTION

A system (apparatus), computer implemented method, and program product for analyzing a problem in a distributed processing business system used to provide a service performs steps comprises identifying the problem; preparing for an audit; performing the audit; reviewing the audit; developing an action plan; developing an execution plan; deploying a solution in accordance with the execution plan; monitoring the deployed solution; and recording lessons learned.

Alternatively, the system, method, and program product may be applied to evaluate the capacity of a distributed processing business system to provide a prospective service. In this alternative embodiment, the system, method, and program product comprises identifying the problem; preparing for an audit; performing the audit; reviewing the audit; preparing a rating table; populating the rating table with results from the audit; calculating a service rating based upon the results entered in the rating table; and presenting the service rating to management. If approved, the service provider develops an action plan; develops an execution plan; deploys a solution in accordance with the execution plan; monitors the deployed solution; and records lessons learned.

### BRIEF DESCRIPTION OF THE SEVERAL VIEWS OF THE DRAWINGS

FIG. 1 illustrates the relationship between a process and a service;

FIG. 2 provides an overview of the problem analysis methodology;

FIG. 3 is a flowchart of the Problem Identification sub-process;

FIG. 4 is an exemplary worksheet used in the Problem Identification sub-process for identifying problems in the project office data;

FIG. 5 is an exemplary worksheet used in the Problem Identification sub-process for identifying problems with a process or processes;

FIG. 6 is an exemplary worksheet used in the Problem Identification sub-process for identifying problems with a procedure or procedures;

FIG. 7 is an exemplary interface/intersection validation form;

FIG. 8 is a flowchart of the Prepare for Audit sub-process;

FIG. 9 is a flowchart of the Perform Audit sub-process;

FIG. 10 is a flowchart of the Review & Record sub-process;

FIG. 11 is a flowchart of the Action Plan Development sub-process;

FIG. 12 is an exemplary exit criteria worksheet;

FIG. 13 is a flowchart of the Execution Plan Development sub-process;

FIG. 14 is a flowchart of the Deploy Solution sub-process;

FIG. 15 is a flowchart of the Reevaluate sub-process;

FIG. 16 is a flowchart of the Monitor Deployment sub-process;

FIG. 17 is a flowchart of the Prospective Account Evaluation process;

FIG. 18 is an exemplary rating table;

FIG. 19 is an exemplary computer network;

FIG. 20 is an exemplary data processing system; and

FIG. 21 is an exemplary memory.

### DETAILED DESCRIPTION OF THE INVENTION

As will be appreciated by one skilled in the art, the present invention may be embodied as a system, programmable apparatus or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The inventive analysis methodology described in detail below generally is applied to business systems that are used to deliver a service to a consumer. In this context, a “consumer” may be internal or external to the service provider, and a “service” represents any function having tangible or intangible value to the consumer. The methodology comprises techniques for evaluating, researching, and analyzing processes and technology associated with a service. More particularly, the methodology provides a means to evaluate, research, and analyze “problems” with processes and technologies associated with a service. Moreover, the methodology may be applied to a service as a whole, to any distinct process used to deliver a service, and may be applied throughout the timeline of a service. The service may be an existing service or a prospective service.

Of course, the term “problem” has many definitions and implications associated with it, which depend on context. For example, poor financial performance or failing to meet contract and customer expectations are conditions that may indicate a problem with the underlying processes or technology. Sometimes, though, the methodology may be invoked even in the absence of any specific problem indicators, such as when a customer or provider believes there is room for improvement.

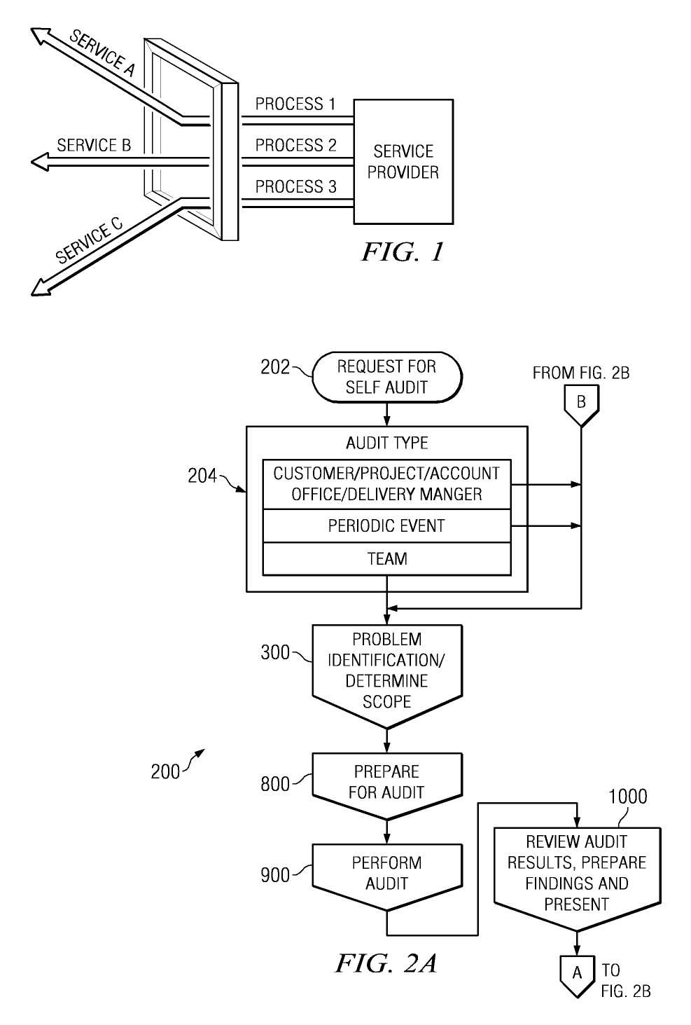

Before describing this methodology in detail, it is important to clarify some nomenclature. In particular, is important to distinguish services from processes and procedures. FIG. 1 is a diagram that illustrates the relationship between a service and processes. “Processes” are internal activities that a business uses to deliver a service. As FIG. 1 indicates, the same process or processes may be used to provide a variety of services. “Technology” refers to the tools that are exploited in the course of executing those processes. Technology includes computer hardware and software. “Procedures” are activities that employ the tools to animate the processes that deliver the service.

It also is important to identify the various roles of participants in the activities required to deliver a service. There are four distinct roles within this methodology, although the same individual might fill several roles. A brief overview of these roles is provided here, but more specific responsibilities will be identified as the details of the inventive methodology are described below. First, the “project office” or “account office” is responsible for ensuring that service is delivered according to contractual obligations, and for monitoring the financial performance of the service delivery. Second, a “service delivery manager” or “account manager” is responsible for delivering all services for a specific account according to contractually defined service-level agreements. Third, an “auditor” is responsible for the auditing activities described below. The auditor also is responsible for coordinating all activities, developing the scope of an audit, and processing worksheets. Fourth, the “delivery team” is responsible for executing procedures and processes that support service delivery for a specific account in accordance with contractual service-level agreements. Members of the delivery team also participate in developing the scope of an audit, provide input to the audit, and analyze the results of the audit.

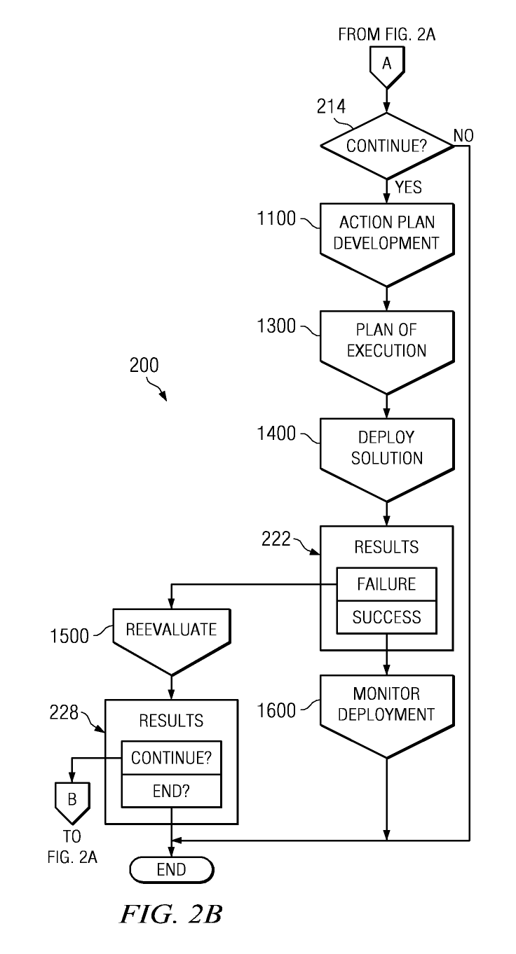

FIG. 2 provides an overview of the inventive methodology applied to an existing service. The methodology is referred to hereinafter as the “problem analysis” methodology. As FIG. 2 illustrates, the problem analysis methodology (200) may be initiated (202) as a periodic event or the result of a request from a customer, the project office, the service delivery manager, or the delivery team (204). Once initiated, the auditor identifies the problem and determines the scope of the audit (300). The auditor then prepares for the audit (800), performs the audit (900), reviews the results of the audit, (1000) and then presents the results to management. Management determines whether to continue (214). If management determines to continue, the auditor develops an action plan for updating the processes or technology (1100). The auditor next prepares a plan of execution consistent with the action plan (1300). The delivery team then deploys the solution in accordance with the plan of execution (1400). As the delivery team deploys the solution, errors or unknown events may impact the success of the deployment (222). If the deployment is unsuccessful, the Reevaluation sub-process is invoked to address these issues (1500). If the deployment is successful, it is monitored in the production environment to ensure that it functions and performs as expected (1600). If unexpected errors are revealed during this monitoring process, the Reevaluation sub-process may be invoked to correct these errors (228). Each of these activities is described in more detail below.

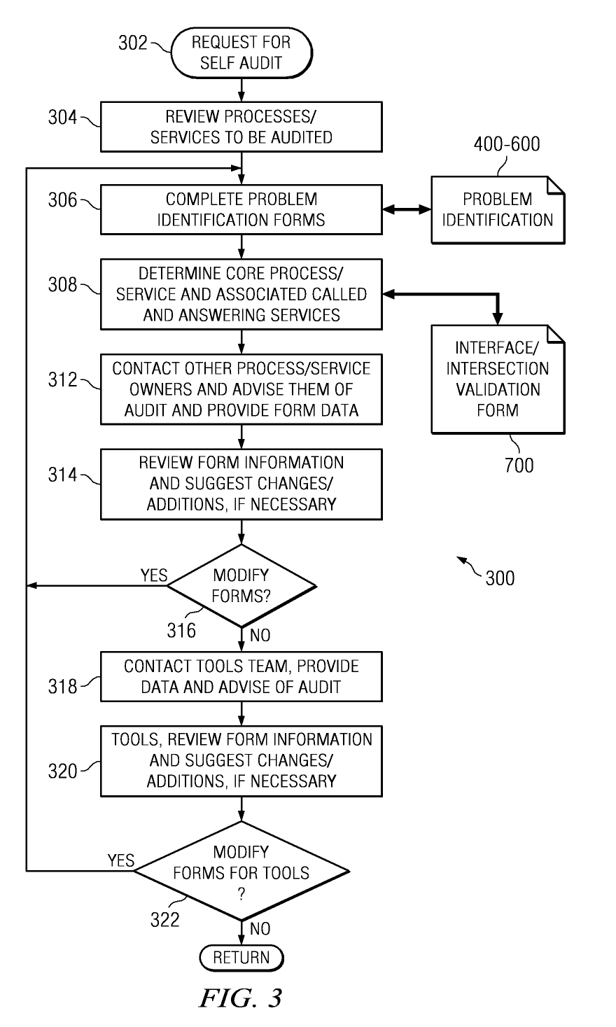

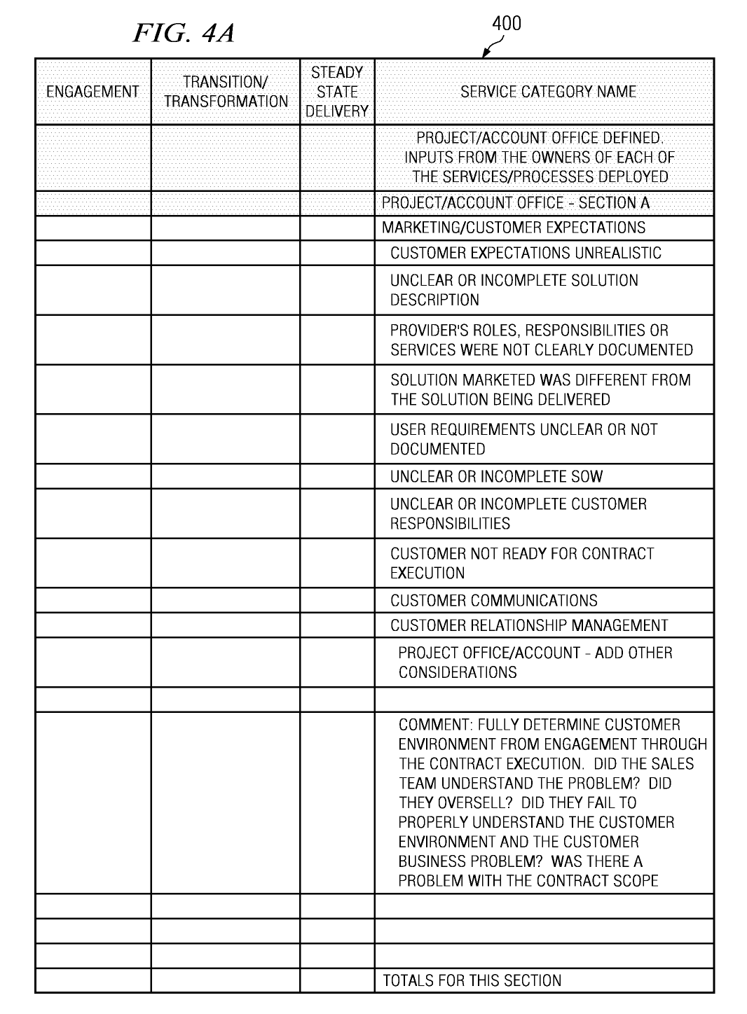

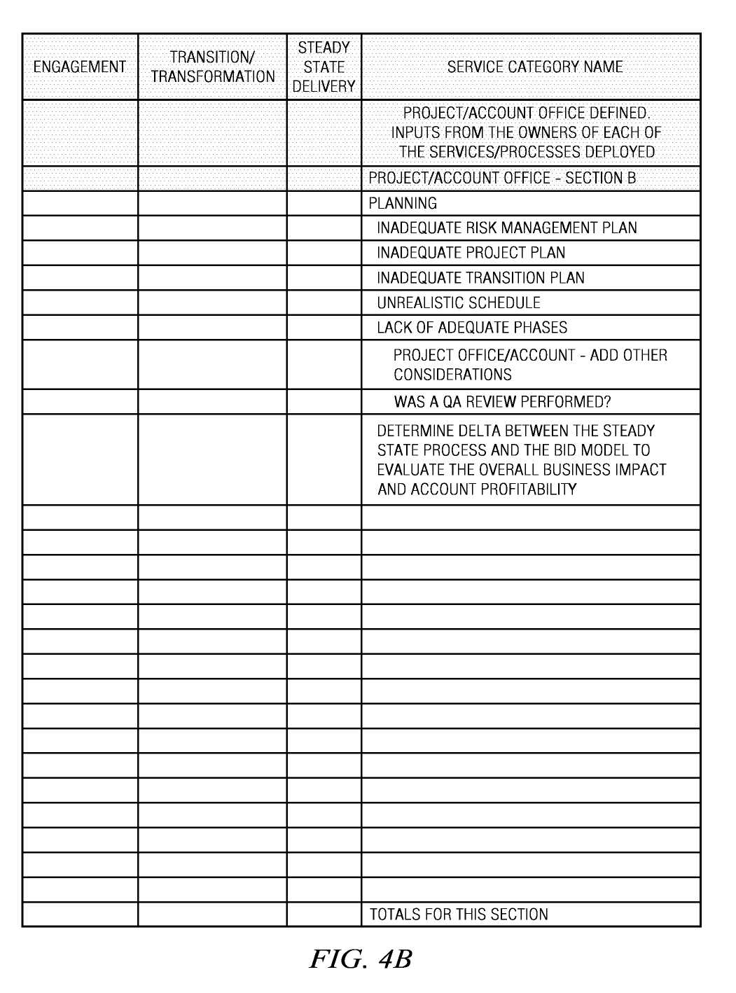

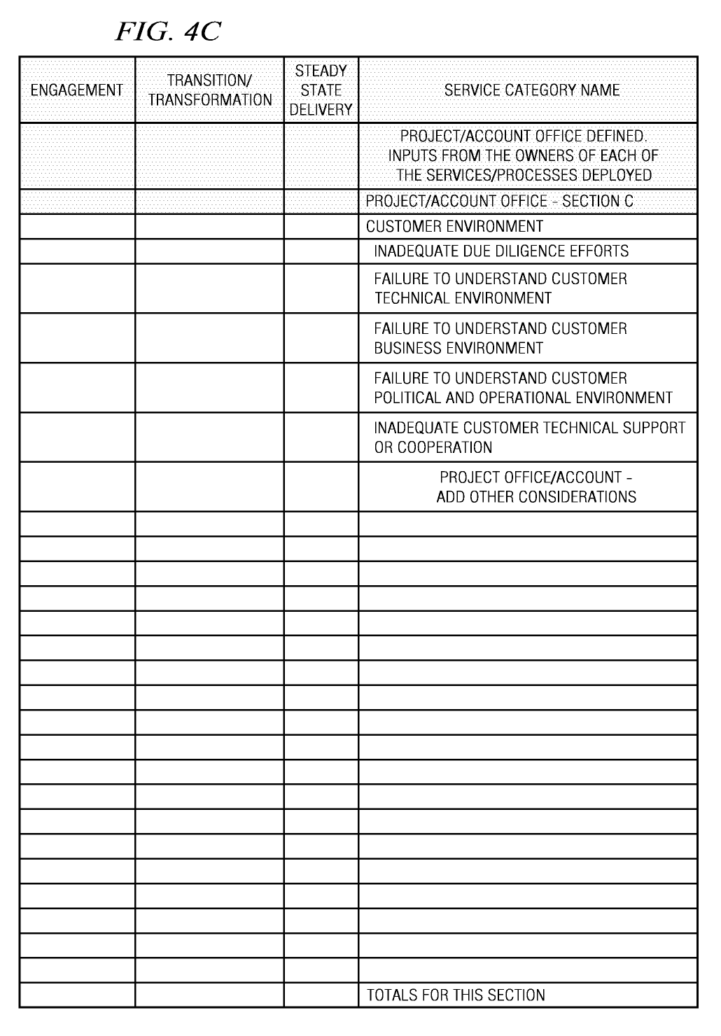

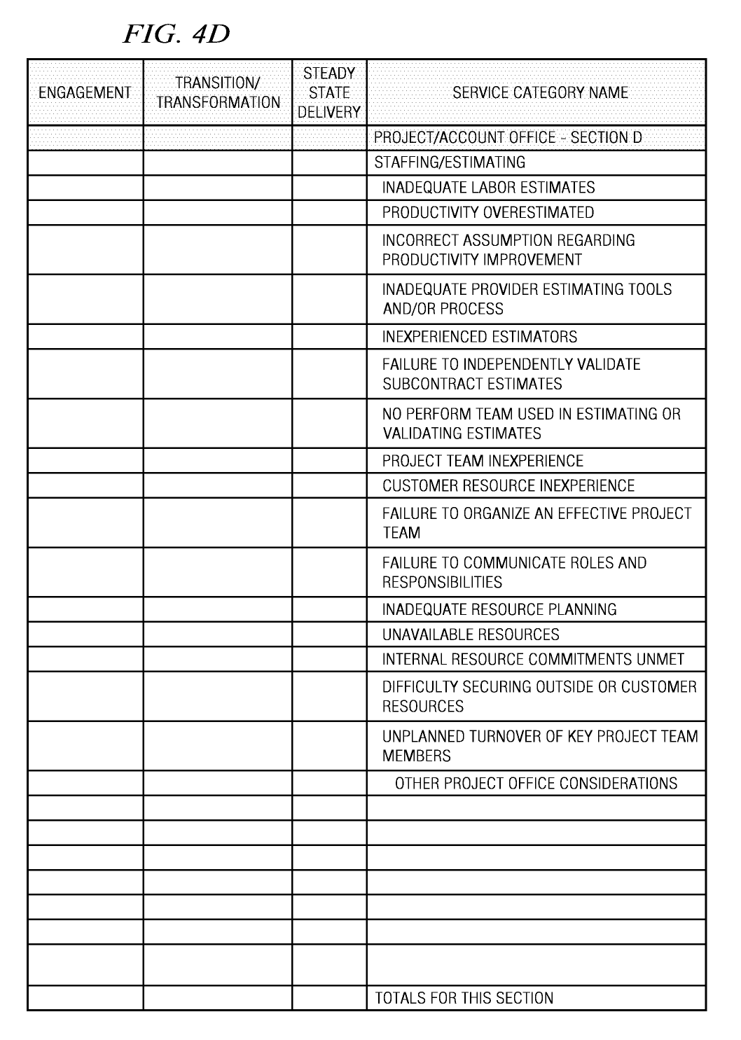

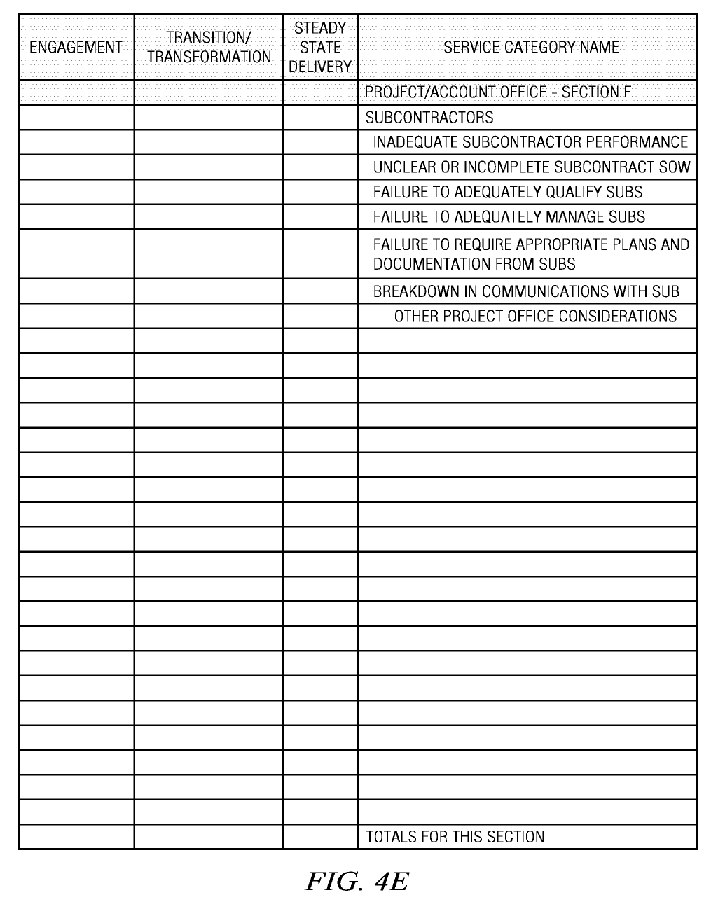

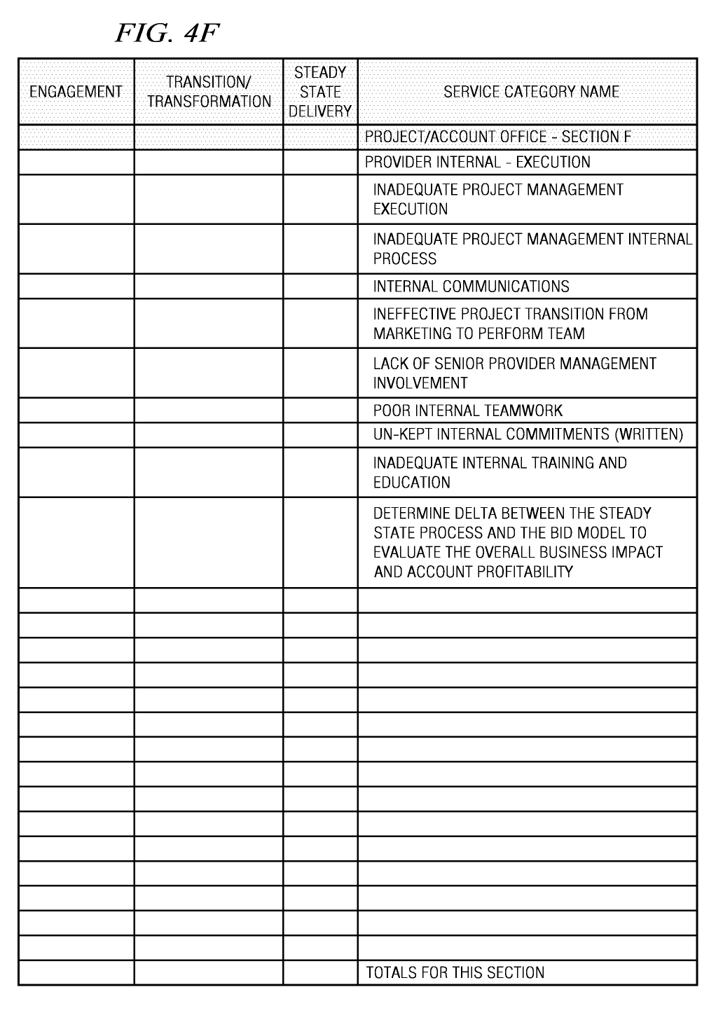

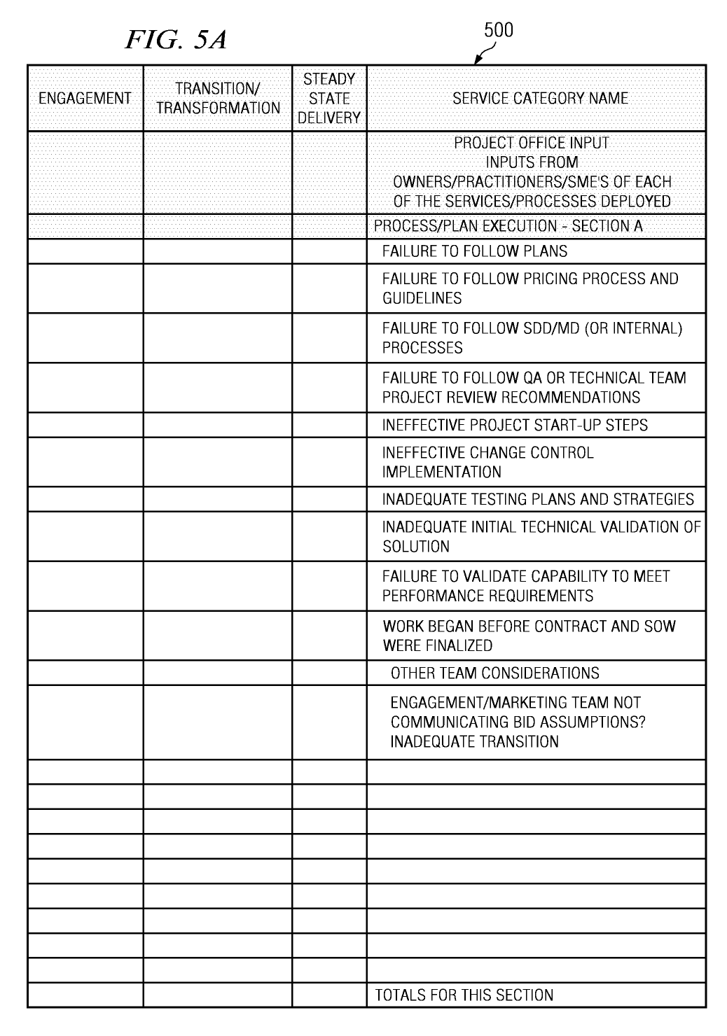

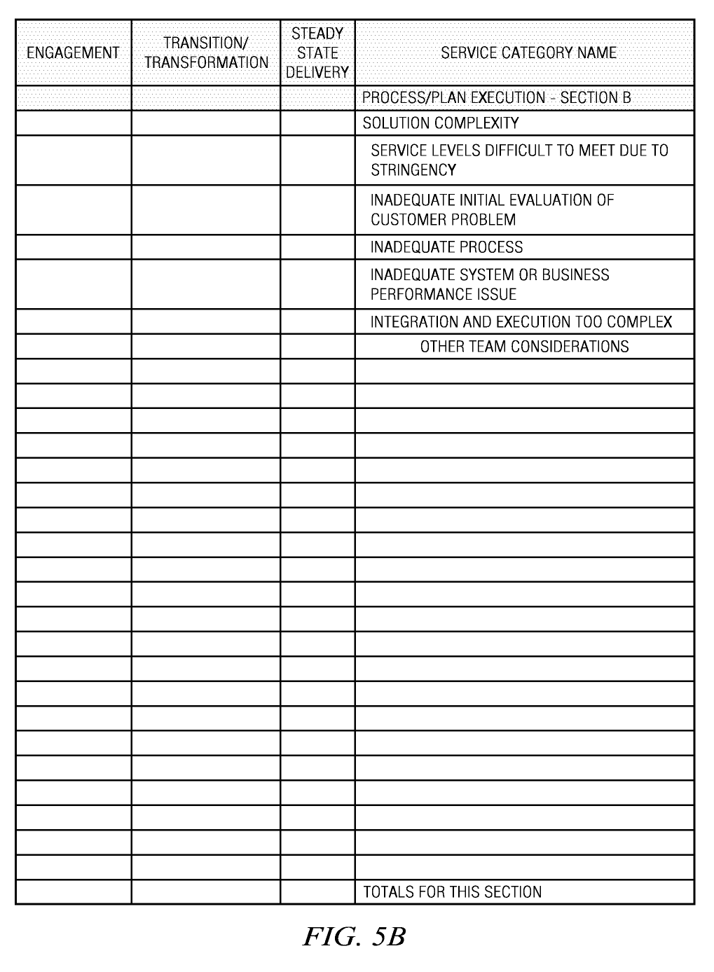

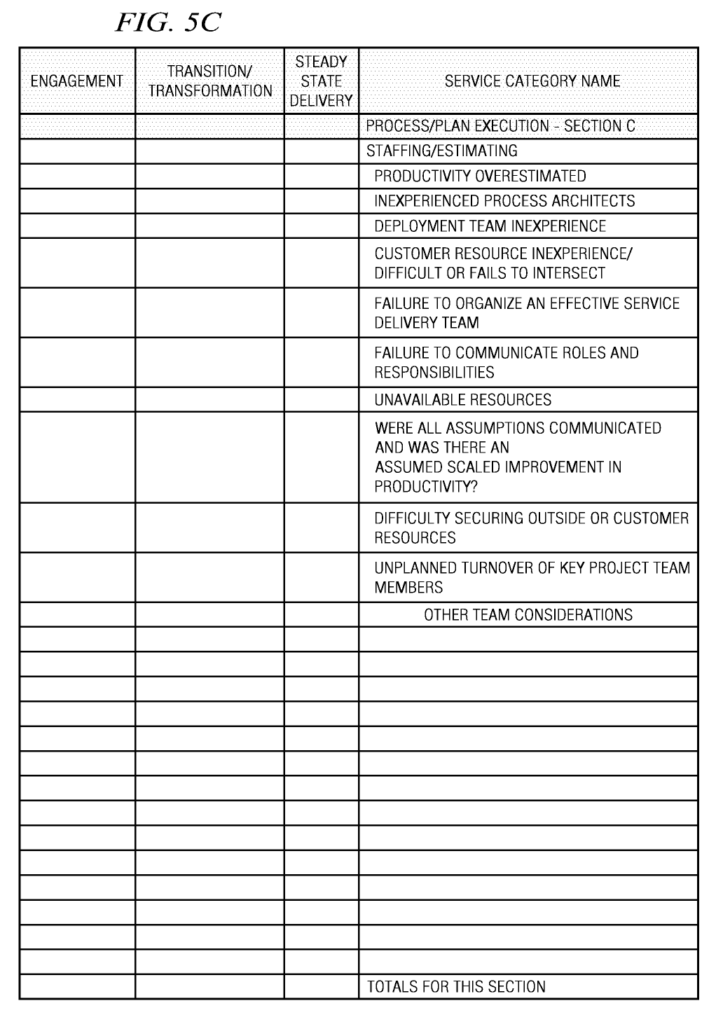

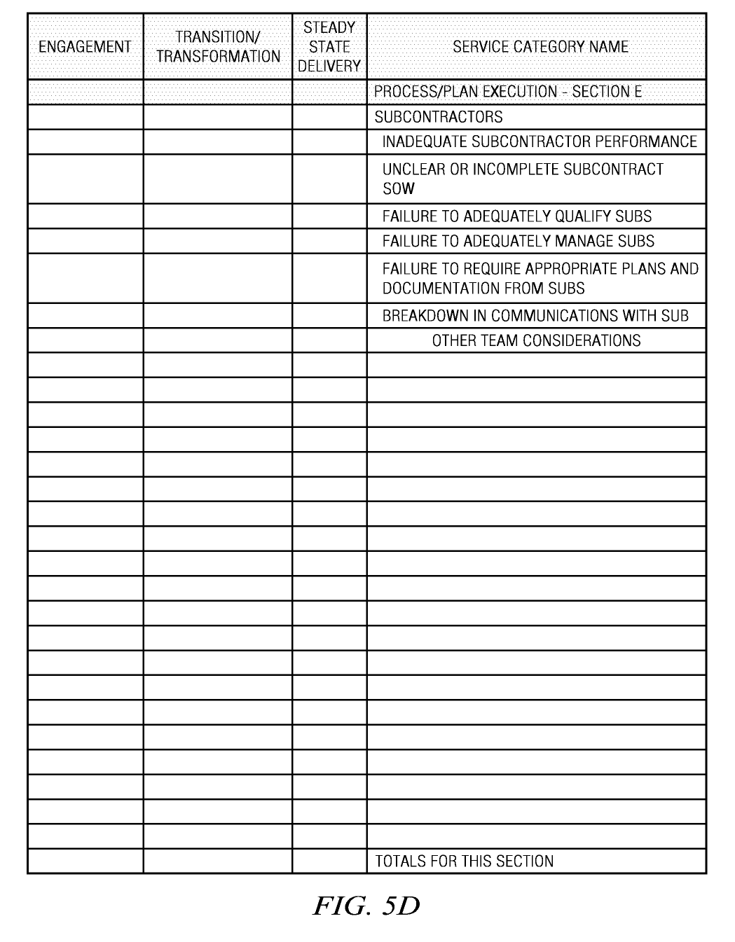

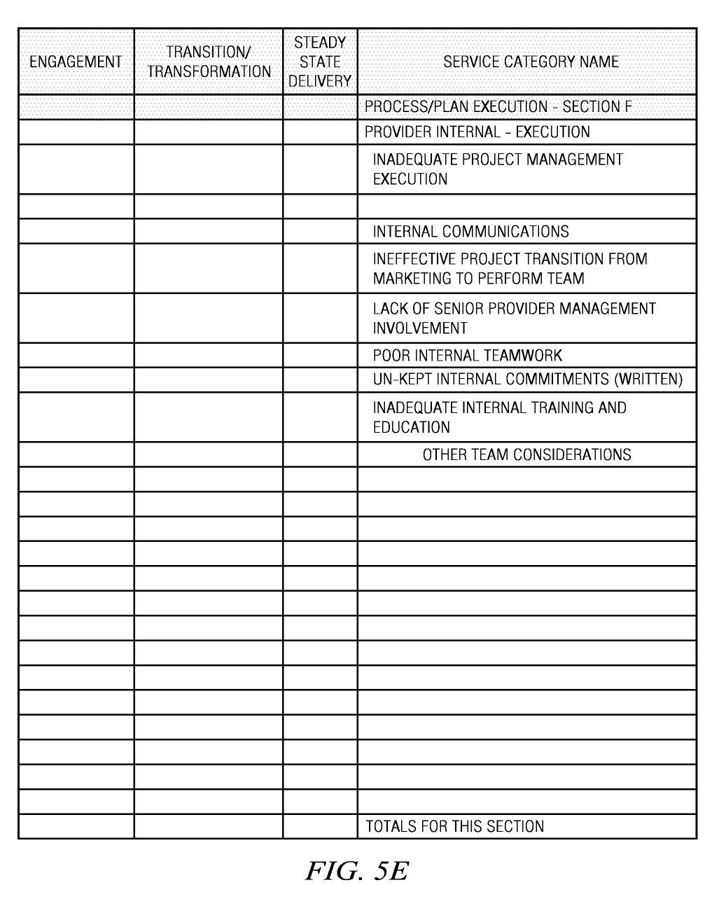

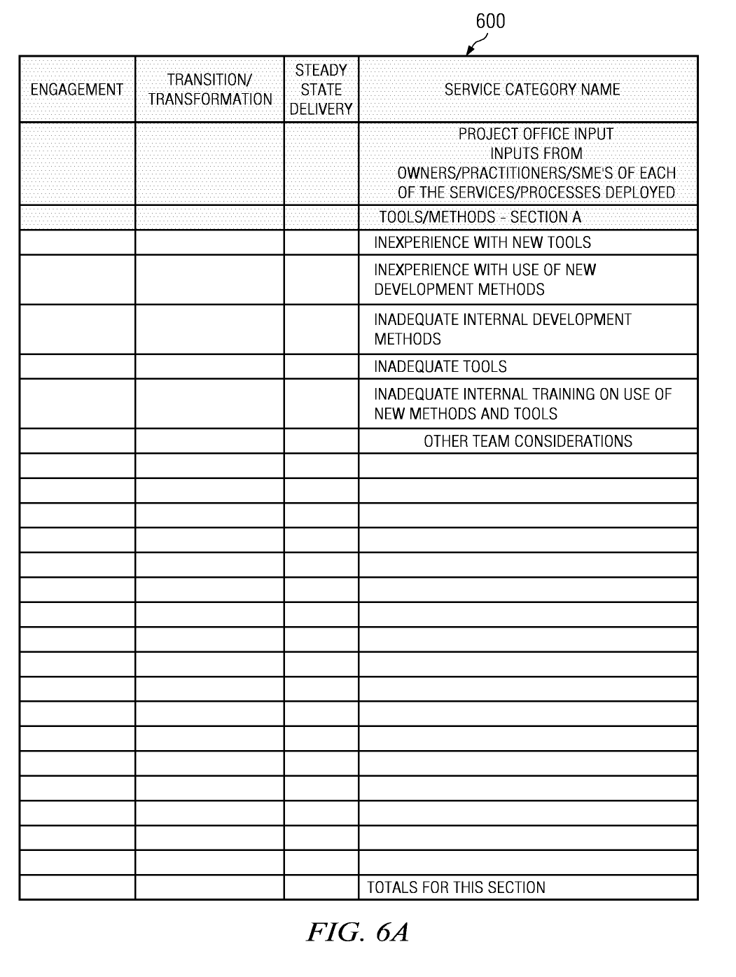

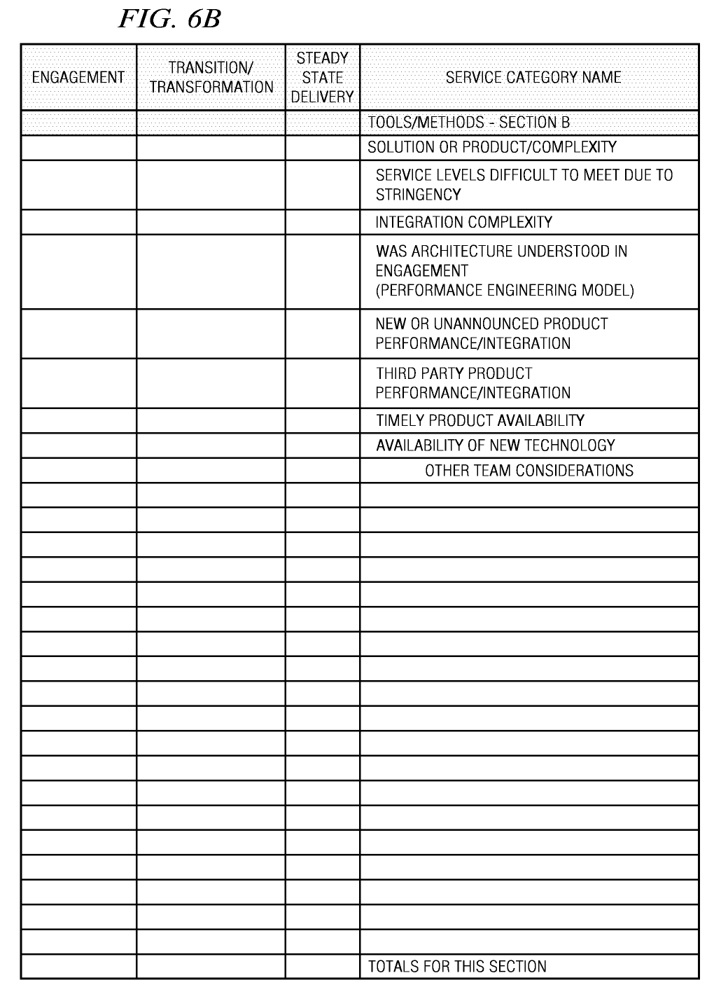

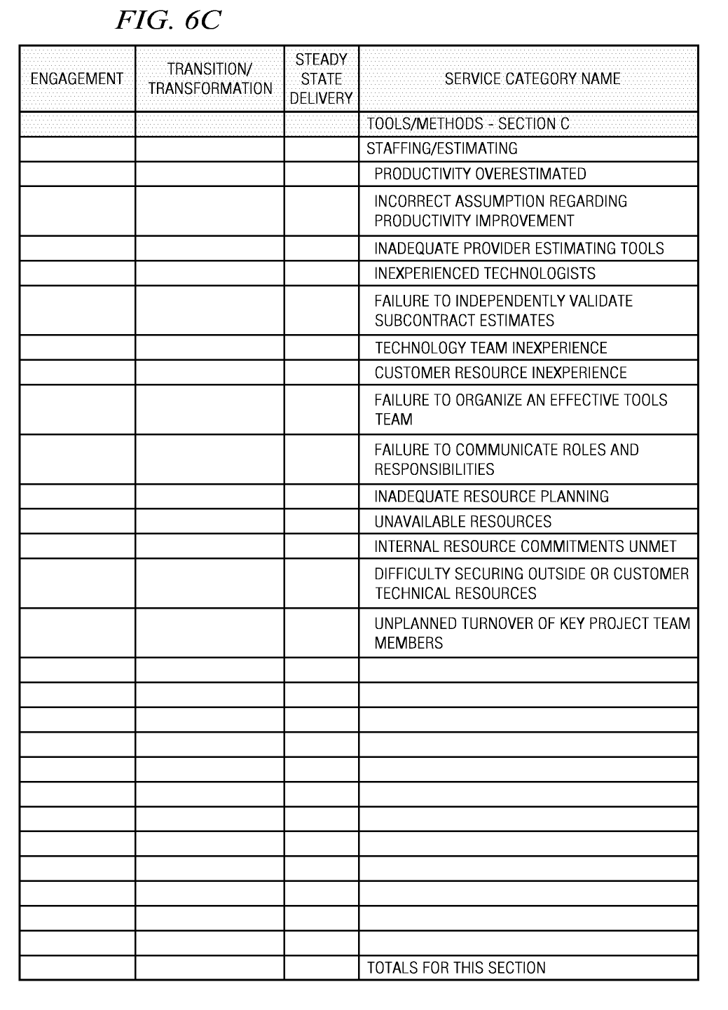

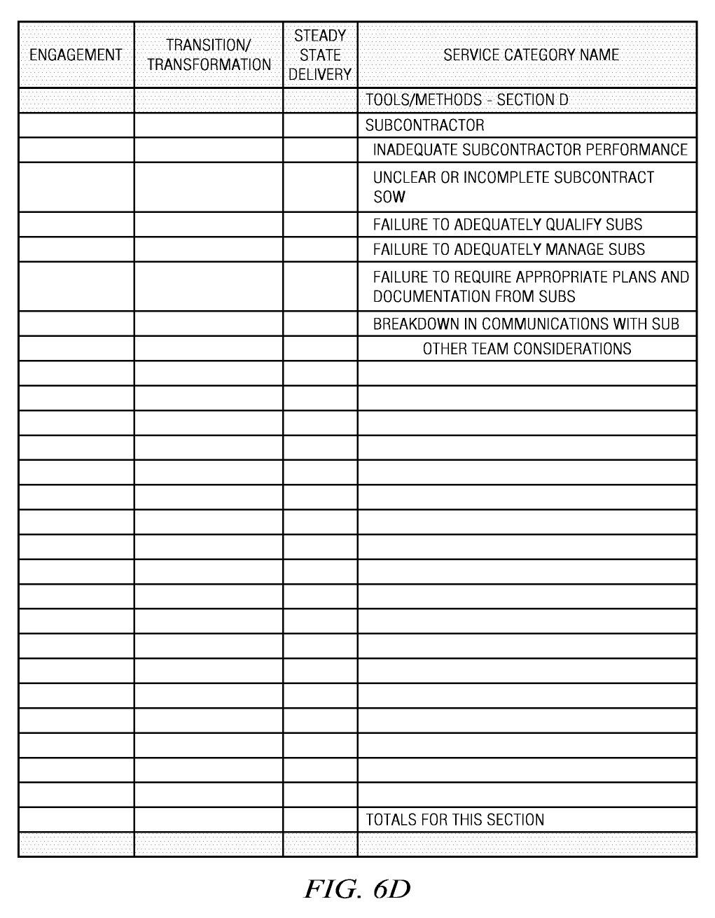

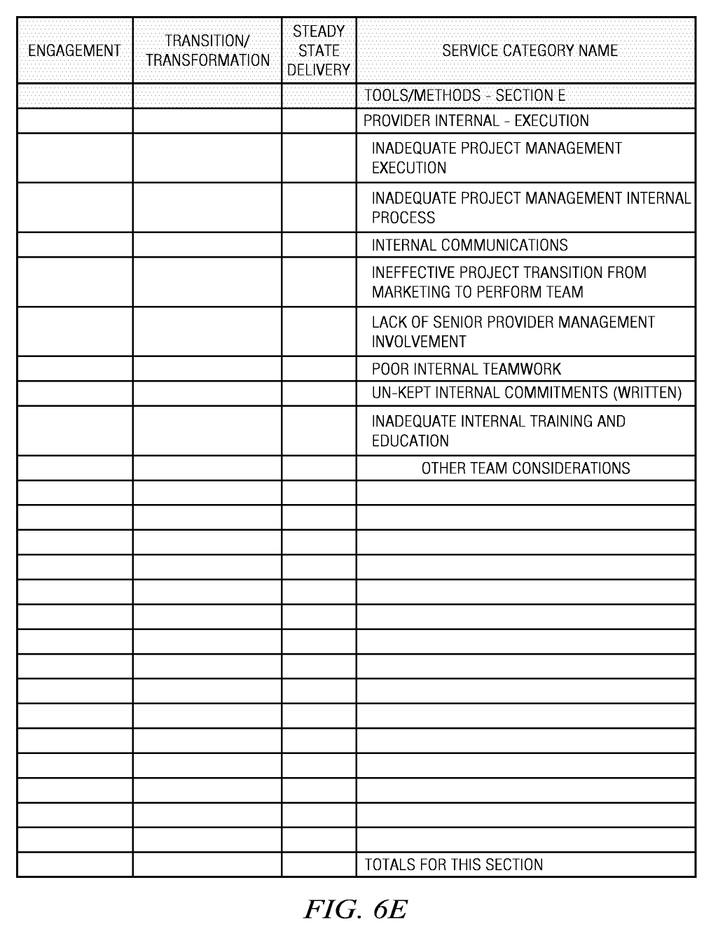

FIG. 3 illustrates the Problem Identification sub-process (300). The Problem Identification sub-process focuses on project office data (which may include service delivery data), processes and procedures, and technology. Upon receiving a request for an audit (302), the auditor reviews the processes and services that are the subject of the request (304). To guide the analysis, an auditor completes a worksheet for the project office data, processes and procedures, and technology (306). Exemplary worksheets are provided in FIGS. 4, 5, and 6. The auditor may request support from associated services to ensure that the best information is included. The auditor then determines the core process or service, and associated called and answering services (308). The selected core process or service generally works with other processes to perform a service. As such, the core service must consider the associated services that contribute to either the success or the failure of the service. The auditor reviews the service from end-to-end, and completes the interface/intersection validation form. An exemplary embodiment of this form, which considers the calls and answers as well as the technology that enables it, is illustrated in FIG. 7. The auditor then contacts other process or service owners and advises them of the audit and provides data from the worksheets and validation form (312). The delivery teams then review their schedules and reserve time for the audit. Next, the team reviews the information provided by the auditor and if necessary offers changes or suggestions to the forms (314). This effort is intended to make the data as complete and robust as possible prior to the audit. If the delivery team offers changes or suggestions (316), the auditor updates the problem identification forms to reflect these changes or suggestions (306). The auditor next provides the forms to technologists and advises them of the impending audit (318). The technologists also review the forms and determine if they can add any information or contribute any change data (320). If necessary (322), the auditor then updates the problem identification forms again (306).

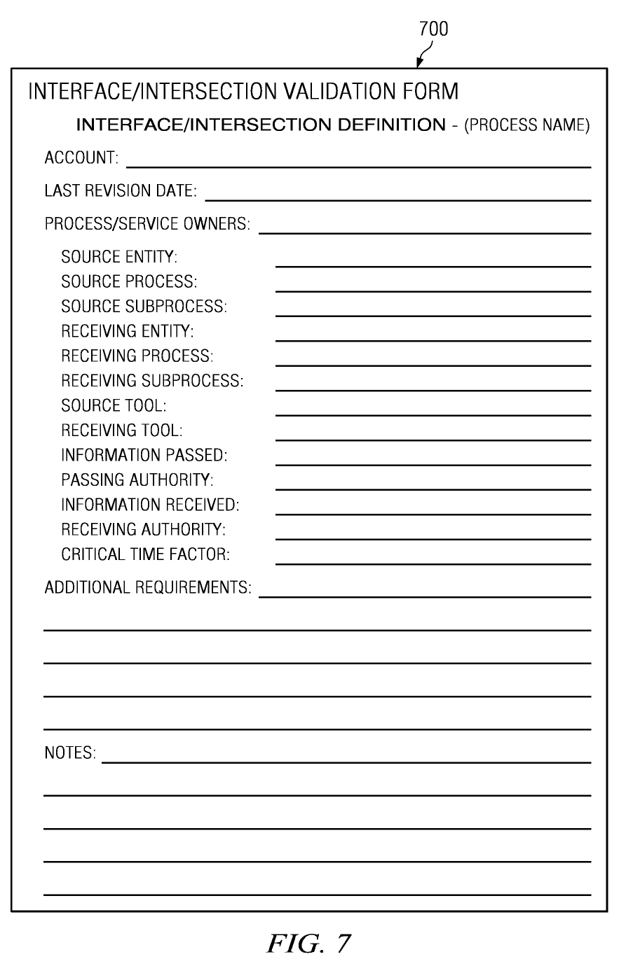

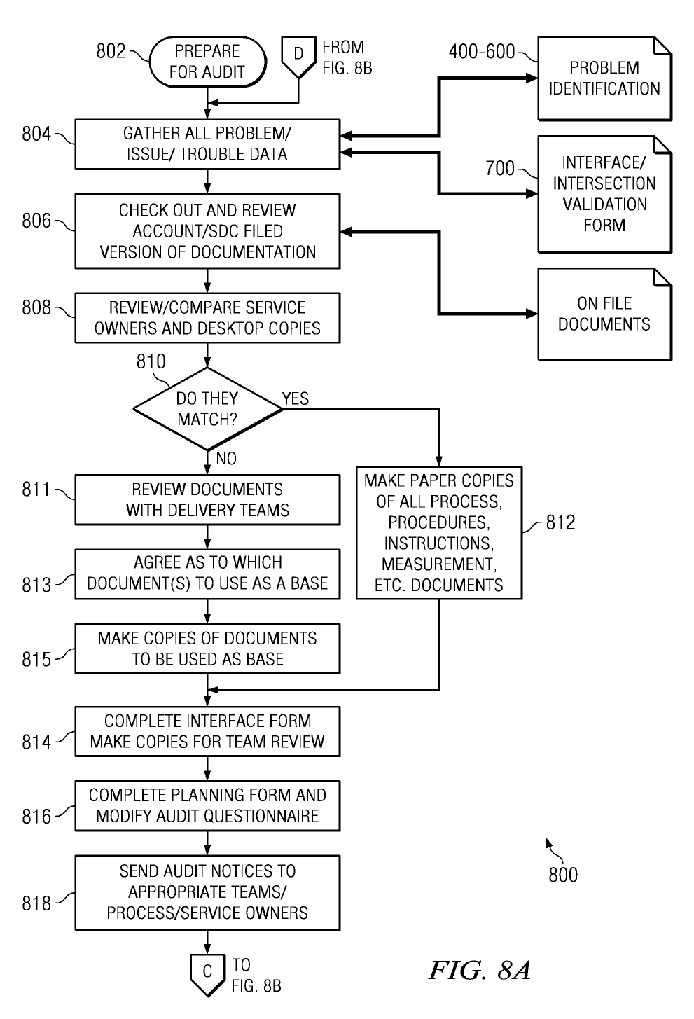

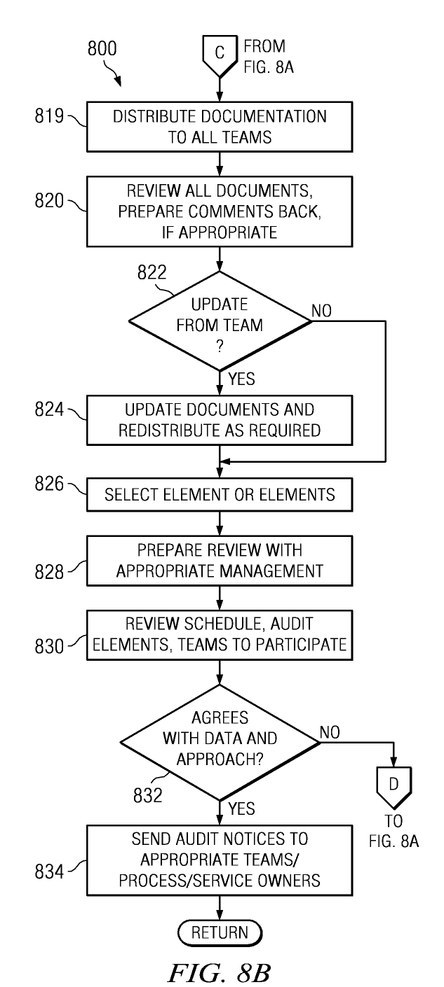

FIG. 8 illustrates the Prepare for Audit sub-process (800). To prepare for an audit (802), an auditor first collects all problem identification worksheets completed during earlier steps (804). The auditor also collects other relevant information, such as process documents, procedures, instructions, policies, measurements, service level agreements, contract details, etc. The auditor then reviews all documents and information (806-808) to ensure that they include consistent data, such as version numbers, the number of pages, workflows, etc. If the data is inconsistent (810), the auditor reviews the documents with the delivery teams (811). The auditor and the delivery teams must then agree which version of the documents or data best addresses the elements of the service (813). If the data is consistent (810) or has been agreed upon (813), the auditor makes paper copies of all documents (812, 815), completes the interface forms, and makes copies for team review (814). The auditor then prepares an audit plan and an audit questionnaire (816). The auditor next sends audit notices to appropriate teams (818). The teams then identify relevant resources and allocate time for the audit. Next, the auditor sends all finalized reference documents to the team members that have been identified to support the audit (819). Each team then reviews the documents as a final check before moving forward (820). This permits opportunity for changes if required (822). The auditor collects all inputs from the teams and reviews them. This review either confirms the data as it is or modifies the data. In the event that data has been modified, the auditor must discuss the modifications to ensure an accurate understanding or determine if the modification is required. If modifications are required, the auditor formally updates the data based on the modifications suggested by the team and the validation of the modifications, and makes copies and distributes copies to the team (824). The auditor then selects the element or elements for the audit (826). The suggested element should be a feature that best exercises as many, if not all, of the features offered in the service to be examined. Several elements may be selected to ensure that all aspects of the service are exercised. The auditor then prepares for a review with management (828), which is intended to inform and gain their concurrence. Management then reviews the audit plan and determines whether to proceed with the audit as planned (830). If management does not concur with the audit plan, the auditor restarts the Prepare for Audit sub-process (832). Otherwise, the auditor sends a second audit notice to the teams (834).

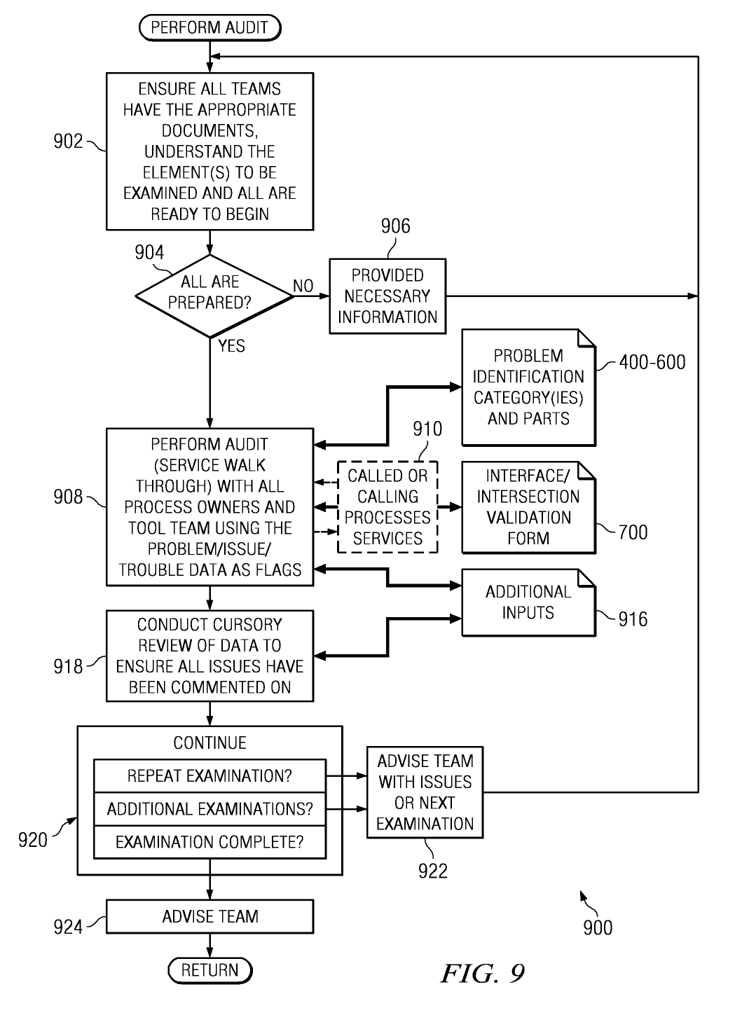

FIG. 9 illustrates the Perform Audit sub-process (900) in detail. The auditor begins the sub-process by verifying that all team members have the most up-to-date documents to be used in the audit (902). The auditor also ensures that all team members know the objectives and the elements to be used to track and monitor the audit (904). The auditor provides missing information, if necessary (906), and then proceeds with the audit walk-through. In the audit walk-through, the service is called and the operational process begins (910). As the operational process continues, the auditor uses problem identification forms 400-600, interface/intersection form 700, and the audit questionnaire 916 to evaluate each step of the operational process. The auditor also should note technology intersections. Once all audit walk-throughs are complete, the auditor conducts a cursory review of data to ensure that all issues have been commented on (918). After concluding the cursory review, the auditor and the team determine if the examination is complete and the data is sufficient to move forward (920). If the auditor and the team determine that the examination is incomplete, the auditor restarts the Perform Audit sub-process (922). Otherwise, the auditor informs the team that the audit is complete (924).

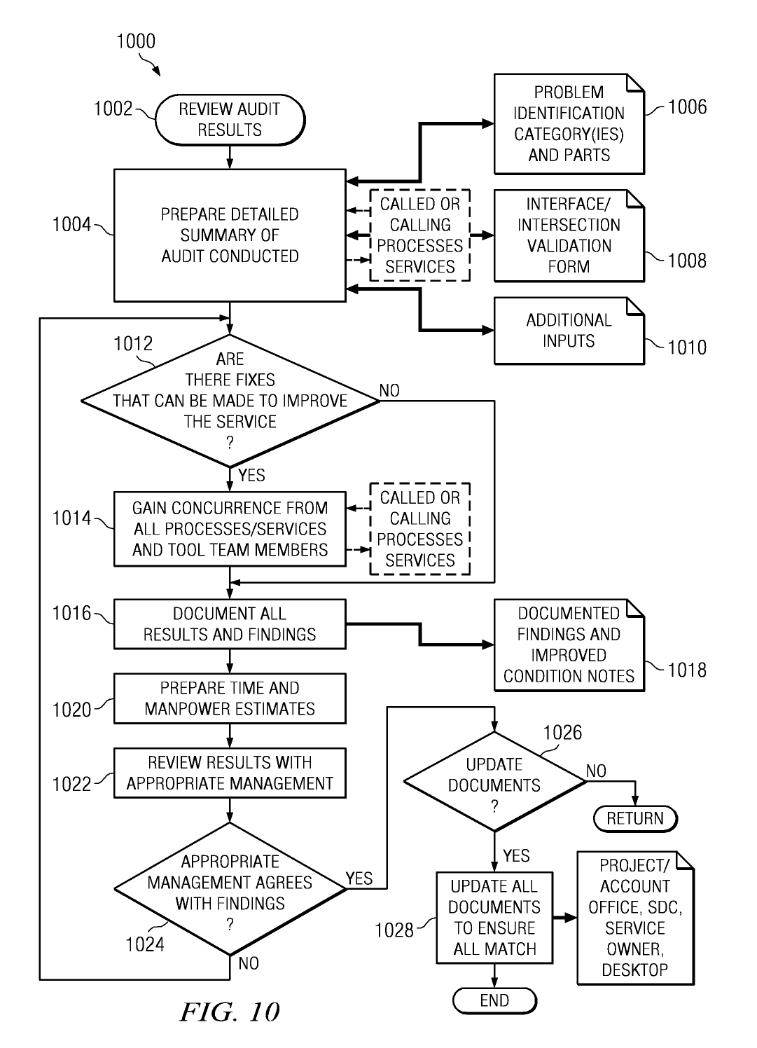

FIG. 10 illustrates the sub-process for reviewing audit results, preparing findings, and presenting findings (1000). The objective of this sub-process is to organize the audit results and findings into a meaningful format that will support the development of an action plan. First, the auditor and the team review all of the data generated (1004). This data includes problem identification forms 400-600, interface/intersection validation form 700, and all other documents 1010 used to review the audit. This information includes, but is not limited to, process charts, procedures, policy documents, etc. The information is formatted so that it provides clear indicators of successful and unsuccessful points of execution. The team then must determine if corrective action can improve the service (1012). If the team determines that corrective action is proper, the team must gain concurrence from the auditor and a commitment to take the corrective action (1014). The team then documents the results and findings, and makes a recommendation (1016). If the results and findings do not suggest a good plan of action or provide a timeframe for development and implementation, the documentation must reflect this (1018). The auditor prepares an estimate of the time and manpower that will be required to take the corrective action (1020). The estimate should consider, at a minimum, the manpower and time for planning and development, implementation, and monitoring. The auditor and team next present the findings to management (1022). This step assists in the validation of the effort and also gains management support for the next steps. If management disagrees with the findings, the auditor may restart this sub-process (1024), or management may instruct the team to update the documentation (1026) to ensure that all are consistent and end the effort (1028).

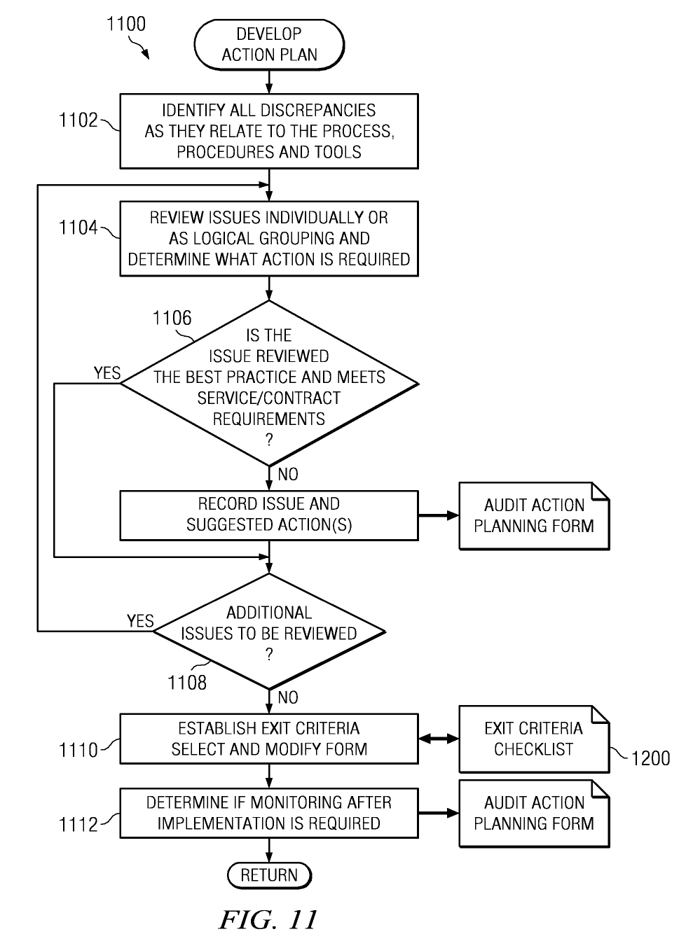

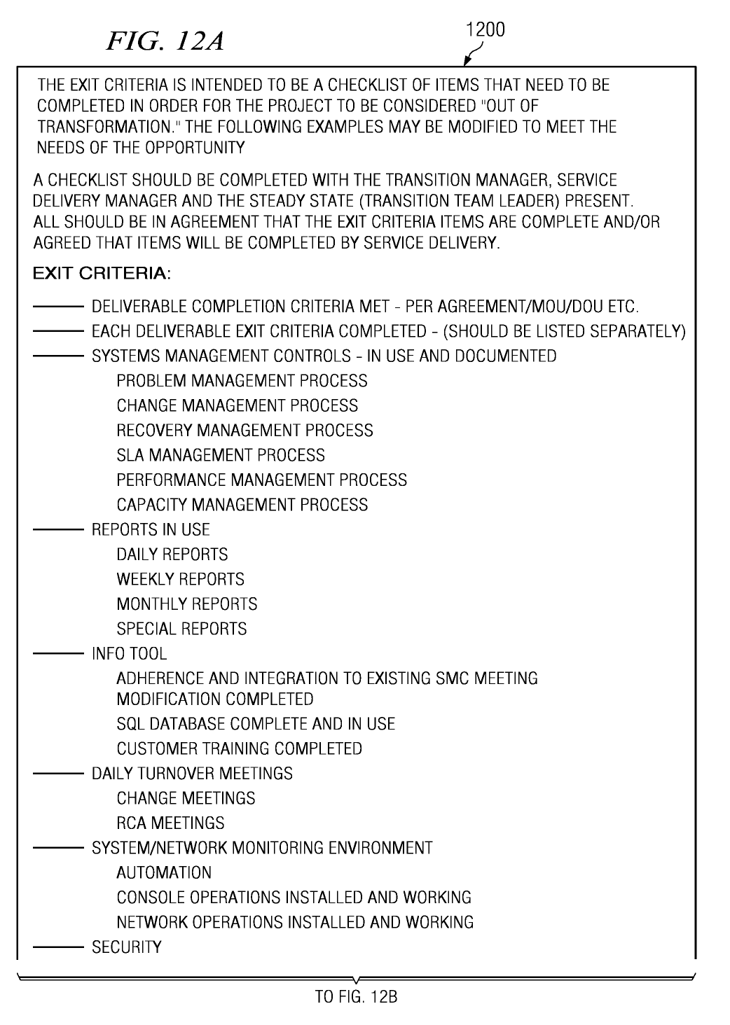

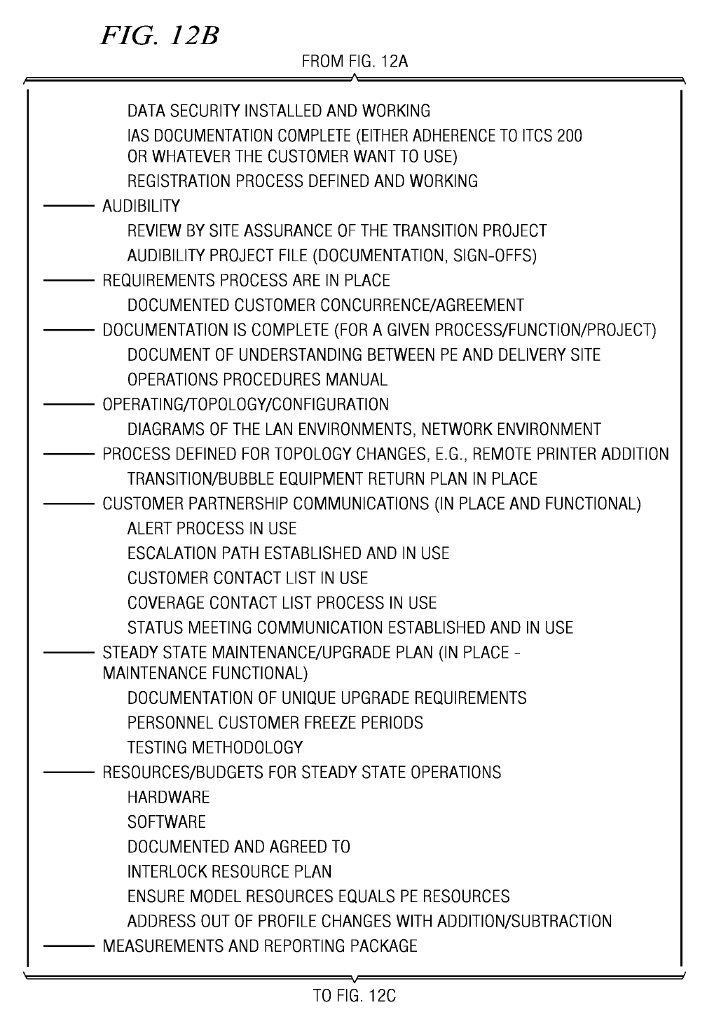

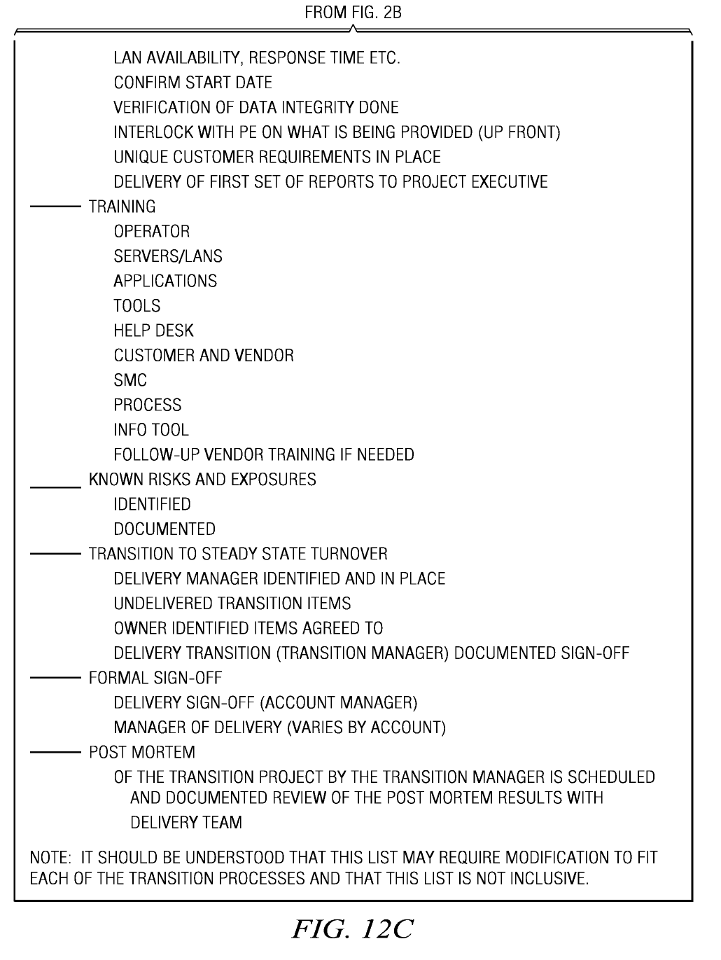

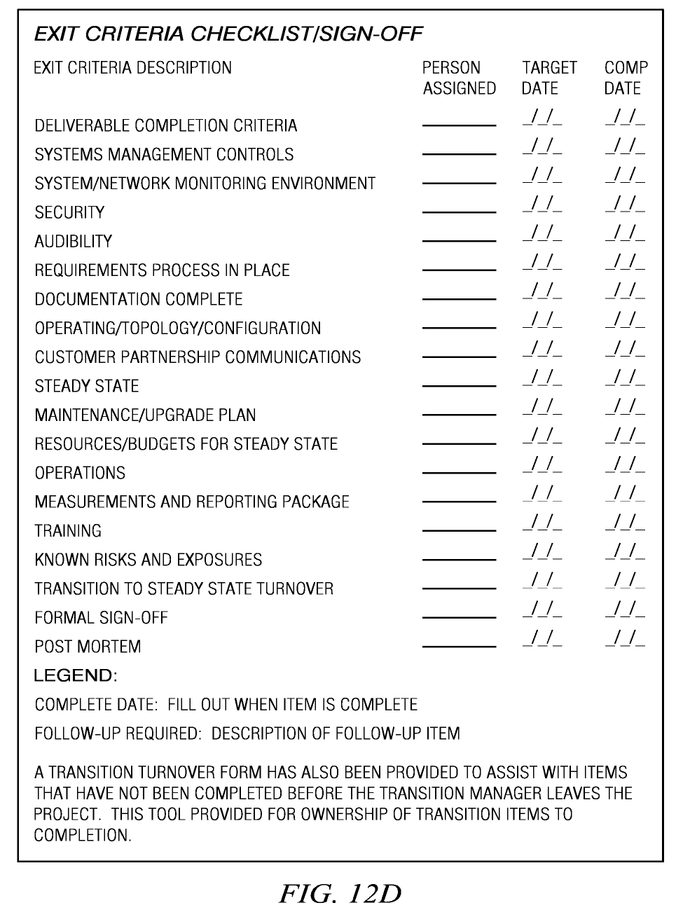

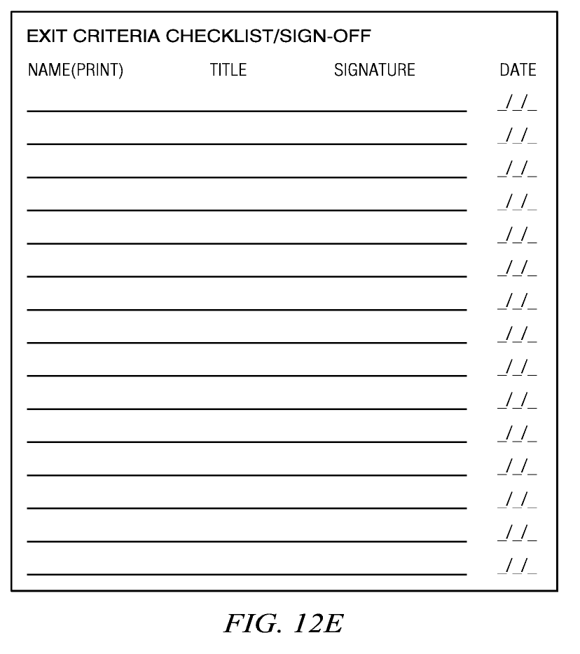

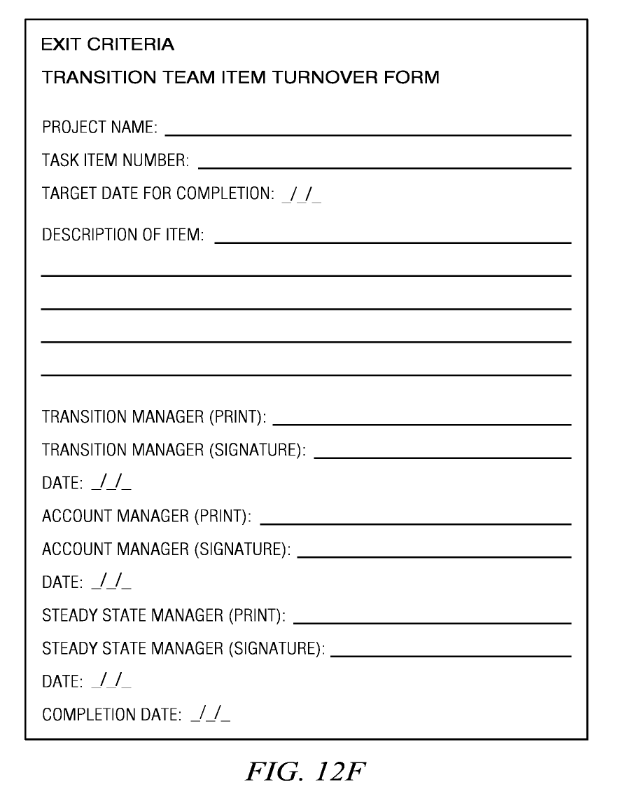

FIG. 11 illustrates the Action Plan Development sub-process (1100). In this sub-process, the team first gathers all data collected during the audit and uses this data to examine each of the components of the service. The team identifies all discrepancies as they relate to the process, procedures, and tools (1102). Next, the team reviews each issue individually or as a logical grouping, and determines what action is required (1104). The team then modifies the process, procedures, tools, and information as required. Changes to the tools should be performed in such a manner that normal production is not affected (1106). The team next begins an end-to-end walk-through of the service to test the corrective action. If additional issues need to be reviewed (1108), this sub-process may be repeated as indicated in FIG. 11. The team then establishes exit criteria and selects a model for demonstrating that the service has been corrected (1110). An exemplary exit criteria worksheet is provided in FIG. 12. Finally, the team must agree if monitoring is required and, if so, the length of time that monitoring is to occur (1112).

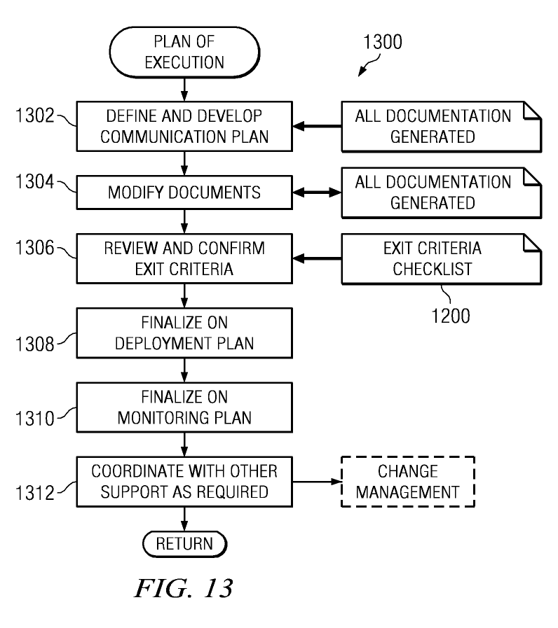

FIG. 13 illustrates the Execution Plan Development sub-process (1300). This sub-process updates the necessary documents, organizes all of the components, and sets in place the plan for deploying the solution. The team first develops a Communication Plan (1302). To develop a communication plan, the team reviews all entities that will be impacted by the release of the solution. From this information, the team creates the appropriate dialogue, which discusses the solution, what it includes, benefits, and when it will be released. The team then makes the final modifications and updates to the documents (1304). This includes policy notations on the process flows and validation of the call and answers requirements in the flow, as well as the technology intersections and validation of the interface. Measurements are noted and the means for creating management reports are in place. Considerations for escalation requirements and procedures also are updated and modified. Exit criteria are then reviewed and confirmed (1306).

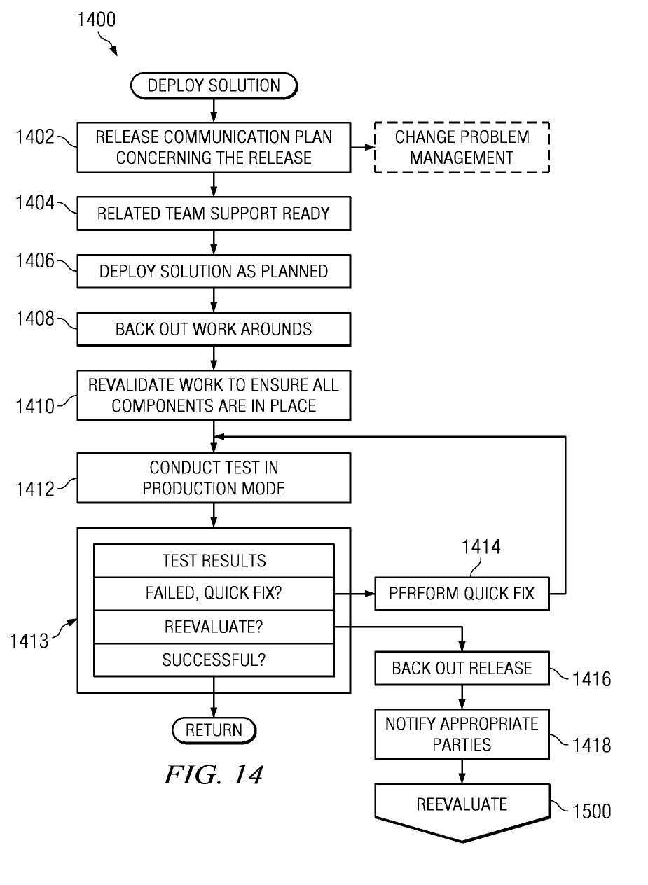

With the Action Plan and the Execution Plan in place, the team then deploys the corrective action in the production environment (1400). This sub-process is illustrated in FIG. 14. The team first releases the Communication Plan to all parties (1402). The auditor then contacts all parties to ensure that the solution is ready to be deployed (1404). Each team member then deploys the solution according to the Execution Plan (1406). The auditor ensures that the process documents are in place, contacts the technology group and ensures that the tools are in place and ready for use, and checks with the delivery team to ensure that the procedures are in place and ready for use. If “work-arounds” are implemented during the deployment process, these items should be backed out and kept ready in case the solution fails (1408). The team then revalidates the work to ensure that all components are in place (1410). This is the last check after the work-arounds have been removed. The solution should now be in place, and test scenarios should be exercised to ensure that the solution is functional in production (1412). The test results should reflect the success of the deployment and of the solution (1413). If one or more of the tests fail, the team should determine if a quick fix can be implemented, or if the solution must be re-evaluated. If a quick fix is feasible, the team implements the quick fix and runs the test scenarios again (1414). If there is no feasible quick fix, the team backs out the release (1416), notifies the appropriate parties (1418), and re-evaluates the effort (see Reevaluate sub-process 1500, below). If the tests are successful, the system is ready for customer use.

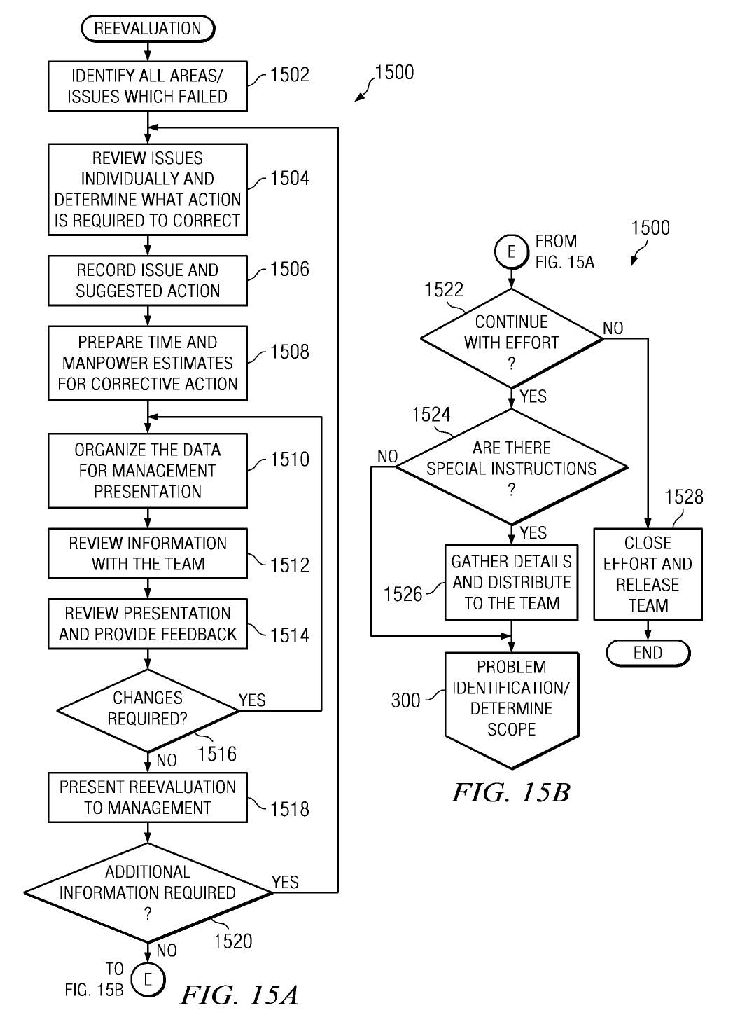

The Reevaluate sub-process (1500), illustrated in FIG. 15, allows the team to review work and present findings to the appropriate management if the solution fails to perform properly in the production environment. Based on the release, the team organizes the items that failed or items, data, or elements that caused the deployment to fail (1502). The team then reviews each item in detail and defines the work required to update or correct the issues (1504). The auditor next gathers all of the information, records the information, and suggests a new plan of action based upon the team input (1506). The team then prepares time and manpower estimates based upon the new plan of action (1508). The auditor then organizes and formalizes the new Action Plan (1510) and estimates, reviews the information with the team (1512-1516), and presents the information to management to gain concurrence or determine if additional information is required (1520). If management requests additional information, the team again reviews the issues and defines the work required to update or correct the issues (1504). Management then decides whether or not to move forward with the effort (1522), and optionally, may provide special instructions (1524). If management provides additional instructions, the auditor gathers any information relevant to the instructions and distributes the information to the team (1526). If management decides not to proceed, the team ensures that the service is performing as it was performing prior to the work, and the team is released from any further responsibilities (1528).

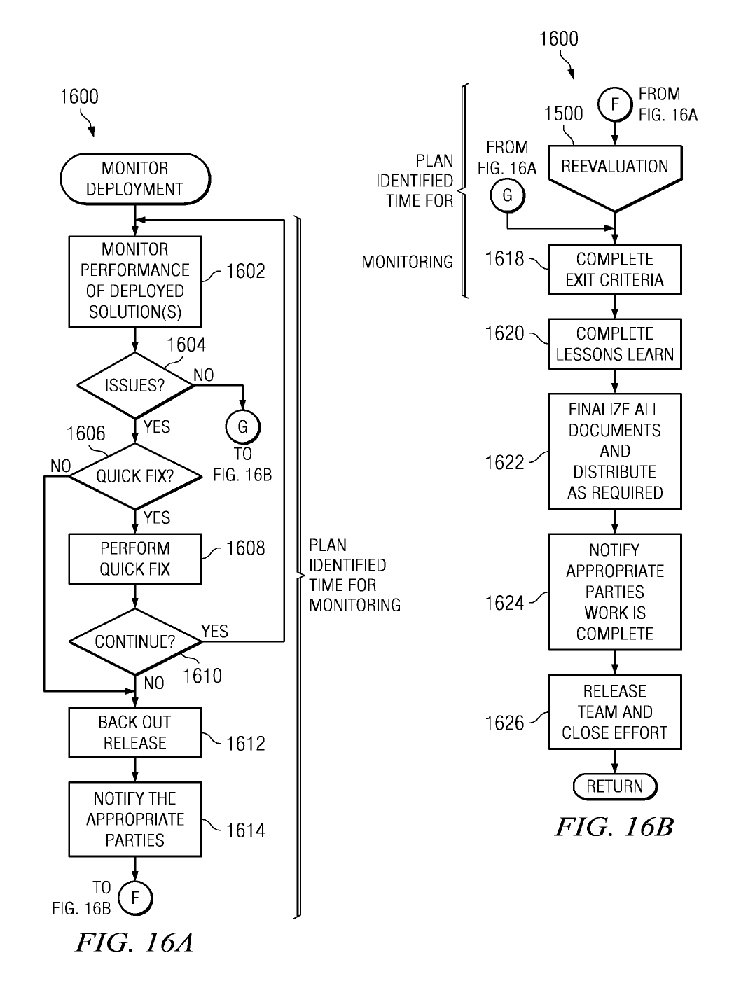

After the solution is deployed, the service provider monitors the operational process to ensure that it is performing as expected (1602), as illustrated in FIG. 16. If monitoring reveals unexpected performance or other issue (1604), the team examines the conditions and determines if a quick fix can be made to correct the issue (1606). If the team has determined that a quick fix is feasible, the team implements the quick fix and updates all documentation to reflect the changes necessitated by the quick fix (1608). The team then determines if the quick fix is working as intended. If the quick fix is working as intended, the team continues the monitoring process until all exit criteria have been satisfied (1610). If the quick fix is not working as intended, the team must reverse the corrective action and restore the original service (1612). The auditor notifies the appropriate parties (1614) that an issue caused the corrective action to fail, and the team begins to re-evaluate the problem (1500), as described above with reference to FIG. 15. When the team determines that the corrective action satisfies all exit criteria (1618) established in the Action Plan, the team completes the exit criteria worksheets and records lessons learned (1620). The auditor then updates all dates, version numbers, etc. in all documents (1622), notifies the appropriate parties that work is complete (1624), and releases the team from the effort (1626).

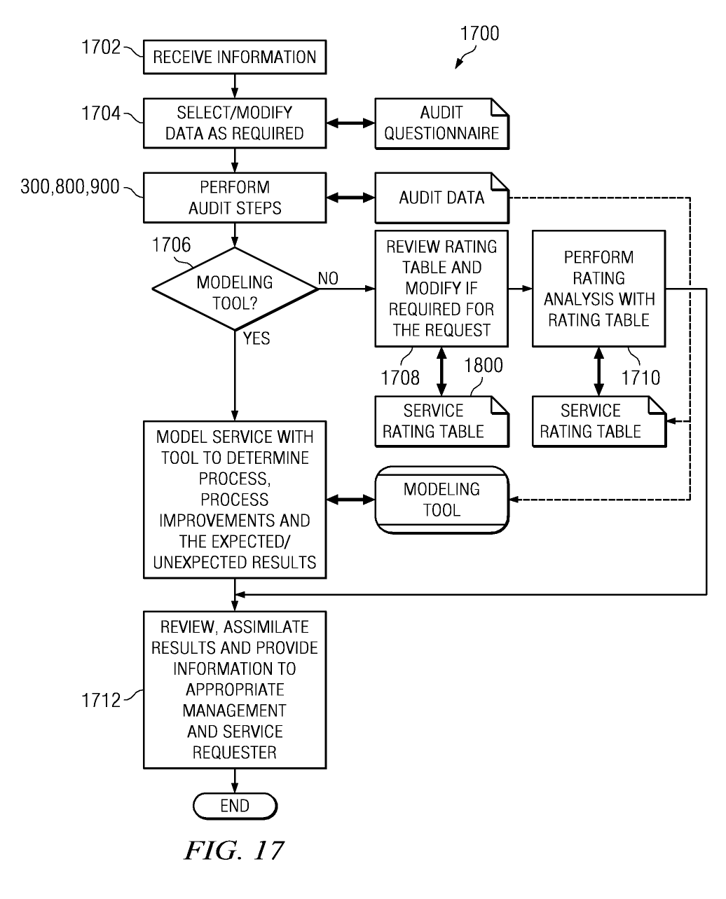

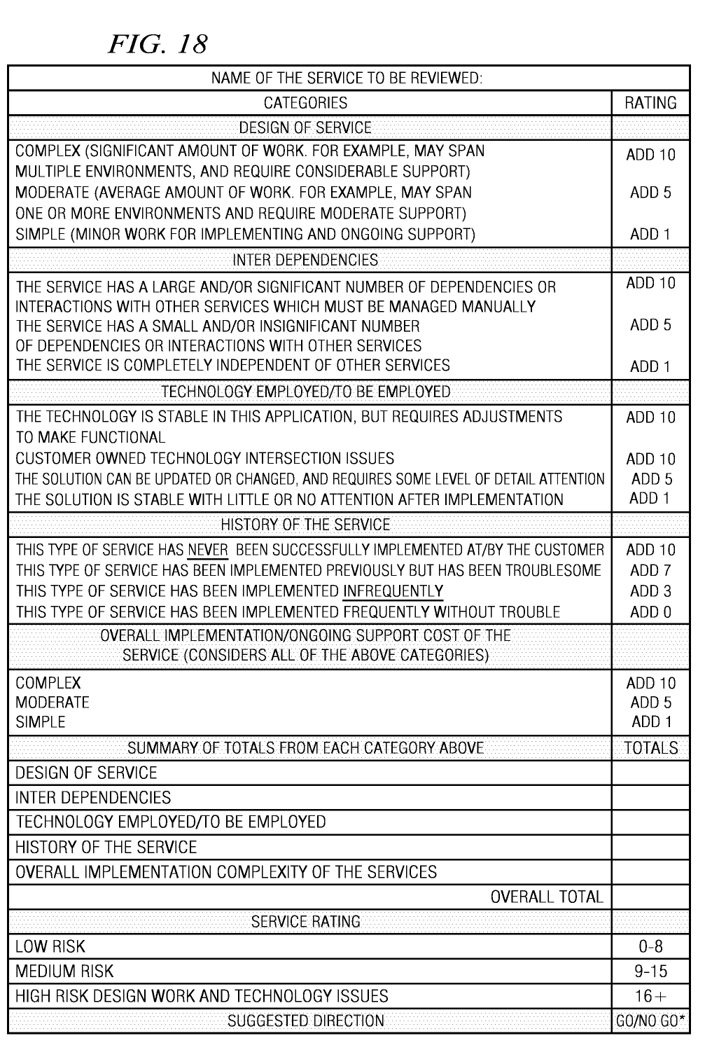

As noted above, the inventive methodology also encompasses the evaluation of prospective services. FIG. 17 illustrates the application of the methodology to such a prospective service. This application of the methodology is referred to here as the “prospective account evaluation” methodology (1700). The object of the prospective account evaluation methodology is to provide assurance to the service provider that a service can be delivered in such a manner that it meets or exceeds customer expectations while producing a profit. In the context of prospective account evaluation methodology (1700), the term “customer” refers to the prospective end-user of the service or services that the service provider is offering. A “service requester” is a liaison between the customer and the service provider. The service requester accepts requests from the customer and coordinates the prospective account evaluation with the service provider. The prospective account evaluation begins when the service requester receives a request to evaluate a new account or a single service (1702). The service requester gathers relevant information and formats it as required for the service provider to review. This information should describe all elements of the service and the desired output. Other information also may describe the customer's current technology, key contacts within the customer's organization, desired schedules, etc. The service provider then receives the request and reviews the information to ensure that the data is adequate to support the evaluation. The service provider also may request the service requester to provide additional information before continuing. The service provider then prepares an audit questionnaire (1704). The service provider then proceeds with steps 300, 800, & 900, described above. The output of this step provides insight into other requirements, the projected time to perform, tools, and interactions with other services. The service provider may have an existing tool for modeling a service or set of services (1706). If the service provider does not have such a tool, then the service provider should prepare a rating table (1708). An exemplary rating table is provided in FIG. 18. This rating table is a template and should be modified to meet the needs of the prospective account. The service provider then populates the rating table with data from the audit (1710) and reviews the rating with appropriate management (1712). As used in the exemplary rating table, a service rating of “low risk” indicates that the service requires a simple design with minimal impact to existing technology infrastructure, and that appropriate levels of customer satisfaction could be achieved with an adequate profit margin. A “medium risk” rating suggests that the service is within the known customer cost and satisfaction tolerance of the service provider, and that the service should produce a profit, but with greater impact on existing infrastructure. A “high risk” rating suggests that the prospective account may not be in the best interests of the customer or the service provider. Ultimately, management is responsible for considering the service rating in light of all other factors and for deciding to enter into a contractual relationship for the delivery of the prospective service. If management decides to enter into such a relationship, many aspects of problem analysis methodology (200) described above may be applied develop operational processes that support delivery of the prospective service. In particular, the service provider may develop an action plan (1100), develop a plan of execution (1300), deploy the processes or service in accordance with the plan of execution (1400), monitor the deployed processes or services (1600), and record lessons learned (1620).

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

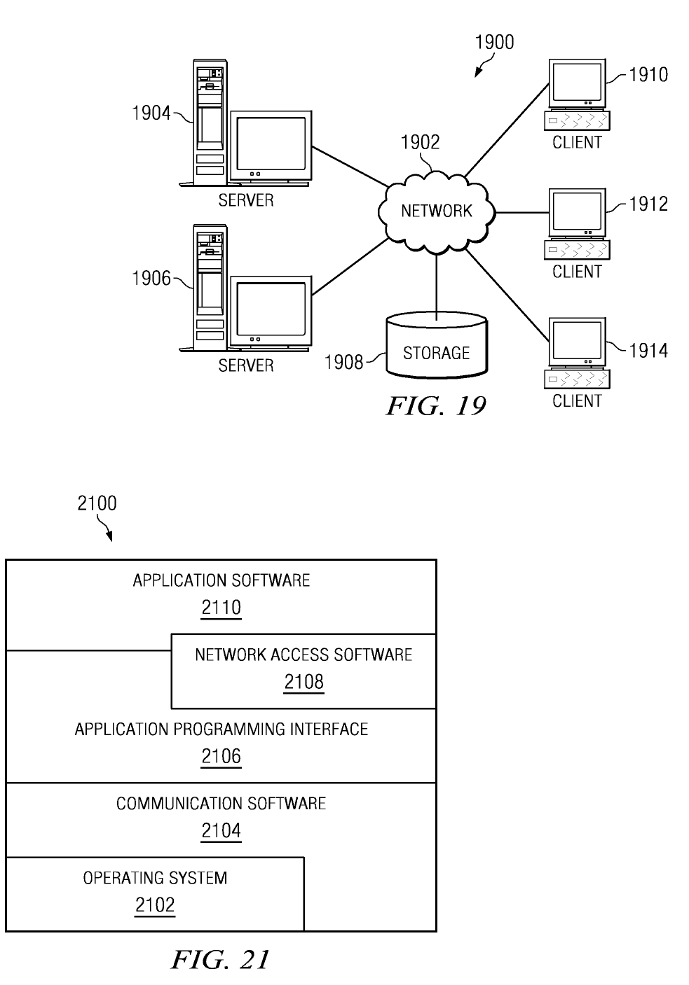

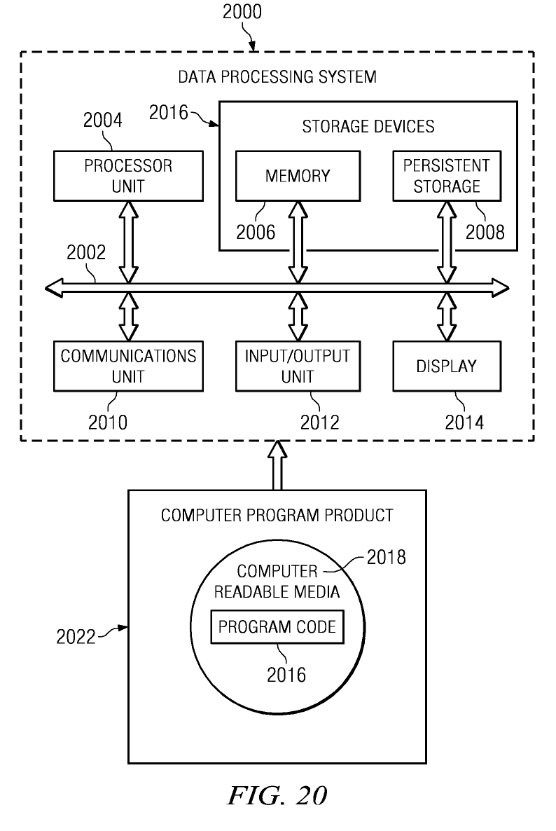

With reference now to the figures and in particular with reference to FIGS. 19-20, exemplary diagrams of data processing environments are provided in which illustrative embodiments may be implemented. It should be appreciated that FIGS. 19-20 are only exemplary and are not intended to assert or imply any limitation with regard to the environments in which different embodiments may be implemented. Many modifications to the depicted environments may be made.

FIG. 19 depicts a pictorial representation of a network of data processing systems in which illustrative embodiments may be implemented. Network data processing system 1900 is a network of computers in which the illustrative embodiments may be implemented. Network data processing system 1900 contains network 1902, which is the medium used to provide communications links between various devices and computers connected together within network data processing system 1900. Network 1902 may include connections, such as wire, wireless communication links, or fiber optic cables.

In the depicted example, server 1904 and server 1906 connect to network 1902 along with storage unit 1908. In addition, clients 1910, 1912, and 1914 connect to network 1902. Clients 1910, 1912, and 1914 may be, for example, personal computers or network computers. In the depicted example, server 1904 provides information, such as boot files, operating system images, and applications to clients 1910, 1912, and 1914. Clients 1910, 1912, and 1914 are clients to server 1904 in this example. Network data processing system 1900 may include additional servers, clients, and other devices not shown.

Program code located in network data processing system 1900 may be stored on a computer recordable storage medium and downloaded to a data processing system or other device for use. For example, program code may be stored on a computer recordable storage medium on server 1904 and downloaded to client 1910 over network 1902 for use on client 1910.

In the depicted example, network data processing system 1900 is the Internet with network 1902 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 1900 also may be implemented as a number of different types of networks, such as for example, an intranet, a local area network (LAN), or a wide area network (WAN). FIG. 19 is intended as an example, and not as an architectural limitation for the different illustrative embodiments.

Turning now to FIG. 20, a diagram of a data processing system is depicted in accordance with an illustrative embodiment. In this illustrative example, data processing system 2000 includes communications fabric 2002, which provides communications between processor unit 2004, memory 2006, persistent storage 2008, communications unit 2010, input/output (I/O) unit 2012, and display 2014.

Processor unit 2004 serves to execute instructions for software that may be loaded into memory 2006. Processor unit 2004 may be a set of one or more processors or may be a multi-processor core, depending on the particular implementation. Further, processor unit 2004 may be implemented using one or more heterogeneous processor systems in which a main processor is present with secondary processors on a single chip. As another illustrative example, processor unit 2004 may be a symmetric multi-processor system containing multiple processors of the same type.

Memory 2006 and persistent storage 2008 are examples of storage devices 2016. A storage device is any piece of hardware that is capable of storing information, such as, for example without limitation, data, program code in functional form, and/or other suitable information either on a temporary basis and/or a permanent basis. Memory 2006, in these examples, may be, for example, a random access memory or any other suitable volatile or non-volatile storage device. Persistent storage 2008 may take various forms depending on the particular implementation. For example, persistent storage 2008 may contain one or more components or devices. For example, persistent storage 2008 may be a hard drive, a flash memory, a rewritable optical disk, a rewritable magnetic tape, or some combination of the above. The media used by persistent storage 2008 also may be removable. For example, a removable hard drive may be used for persistent storage 2008.

Communications unit 2010, in these examples, provides for communications with other data processing systems or devices. In these examples, communications unit 2010 is a network interface card. Communications unit 2010 may provide communications through the use of either or both physical and wireless communications links.

Input/output unit 2012 allows for input and output of data with other devices that may be connected to data processing system 2000. For example, input/output unit 2012 may provide a connection for user input through a keyboard, a mouse, and/or some other suitable input device. Further, input/output unit 2012 may send output to a printer. Display 2014 provides a mechanism to display information to a user.

Instructions for the operating system, applications and/or programs may be located in storage devices 2016, which are in communication with processor unit 2004 through communications fabric 2002. In these illustrative examples the instruction are in a functional form on persistent storage 2008. These instructions may be loaded into memory 2006 for execution by processor unit 2004. The processes of the different embodiments may be performed by processor unit 2004 using computer implemented instructions, which may be located in a memory, such as memory 2006.

These instructions are referred to as program code, computer usable program code, or computer readable program code that may be read and executed by a processor in processor unit 2004. The program code in the different embodiments may be embodied on different physical or tangible computer readable media, such as memory 2006 or persistent storage 2008.

Program code 2018 is located in a functional form on computer readable media 2020 that is selectively removable and may be loaded onto or transferred to data processing system 2000 for execution by processor unit 2004. Program code 2018 and computer readable media 2020 form computer program product 2020 in these examples. In one example, computer readable media 2020 may be in a tangible form, such as, for example, an optical or magnetic disc that is inserted or placed into a drive or other device that is part of persistent storage 2008 for transfer onto a storage device, such as a hard drive that is part of persistent storage 2008. In a tangible form, computer readable media 2018 also may take the form of a persistent storage, such as a hard drive, a thumb drive, or a flash memory that is connected to data processing system 2000. The tangible form of computer readable media 2018 is also referred to as computer recordable storage media. In some instances, computer readable media 2020 may not be removable.

Alternatively, program code 2018 may be transferred to data processing system 2000 from computer readable media 2018 through a communications link to communications unit 2010 and/or through a connection to input/output unit 2012. The communications link and/or the connection may be physical or wireless in the illustrative examples. The computer readable media also may take the form of non-tangible media, such as communications links or wireless transmissions containing the program code.

In some illustrative embodiments, program code 2016 may be downloaded over a network to persistent storage 2008 from another device or data processing system for use within data processing system 2000. For instance, program code stored in a computer readable storage medium in a server data processing system may be downloaded over a network from the server to data processing system 2000. The data processing system providing program code 2016 may be a server computer, a client computer, or some other device capable of storing and transmitting program code 2016. The different components illustrated for data processing system 2000 are not meant to provide architectural limitations to the manner in which different embodiments may be implemented. The different illustrative embodiments may be implemented in a data processing system including components in addition to or in place of those illustrated for data processing system 2000. Other components shown in FIG. 20 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 2000 is any hardware apparatus that may store data. Memory 2006, persistent storage 2008 and computer readable media 2018 are examples of storage devices in a tangible form.

In another example, a bus system may be used to implement communications fabric 2002 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 2006 or a cache such as found in an interface and memory controller hub that may be present in communications fabric 2002.

Turning to FIG. 21, typical software architecture for a server-client system is depicted in accordance with an illustrative embodiment. At the lowest level, operating system 2102 is utilized to provide high-level functionality to the user and to other software. Such an operating system typically includes a basic input output system (BIOS). Communication software 2104 provides communications through an external port to a network, such as the Internet, via a physical communications link by either directly invoking operating system functionality or indirectly bypassing the operating system to access the hardware for communications over the network.

Application programming interface (API) 2106 allows the user of the system, such as an individual or a software routine, to invoke system capabilities using a standard consistent interface without concern for how the particular functionality is implemented. Network access software 2108 represents any software available for allowing the system to access a network. This access may be to a network, such as a local area network (LAN), wide area network (WAN), or the Internet. With the Internet, this software may include programs, such as Web browsers. Application software 2110 represents any number of software applications designed to react to data through the communications port to provide the desired functionality the user seeks. Applications at this level may include those necessary to handle data, video, graphics, photos or text, which can be accessed by users of the Internet. The mechanism of View Element Adjuster 470 (See FIG. 4) may be implemented within communications software 2104 in these examples.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A programmable apparatus for analyzing a problem in a distributed processing business system used to provide a service, the programmable apparatus comprising:
a computer having a processor connected to a memory;
a program in the memory of the computer to cause the computer to perform steps comprising:
identifying the problem;
processing the audit;
processing an action plan;
processing an execution plan;
deploying a solution in accordance with the execution plan;
monitoring the deployed solution; and
processing lessons learned.

2. The programmable apparatus of claim 1 wherein identifying the problem comprises:
processing a problem identification form to evaluate the service;
identifying a core process from the problem identification form; and
processing an interface form to evaluate the interface between the core process and associated services.

3. The programmable apparatus of claim 2 wherein processing the problem identification form comprises:
processing a first worksheet to evaluate project office data associated with the service;
processing a second worksheet to evaluate processes and procedures associated with the service; and
processing a third worksheet to evaluate the technology associated with the service.

4. The programmable apparatus of claim 2 wherein preparing for the audit comprises:
processing documents associated with the service;
processing an audit questionnaire;
processing approval of the audit questionnaire and the identified core process from management; and
sending audit notices to a delivery team.

5. The programmable apparatus of claim 4 wherein performing the audit comprises:
executing the core process; and
evaluating the core process in accordance with the problem identification form, the interface form, and the audit questionnaire.

6. The programmable apparatus of claim 2 wherein developing an action plan comprises:
identifying discrepancies between the core process and associated procedures and tools;
resolving the discrepancies; and
establishing exit criteria.

7. The programmable apparatus of claim 1 wherein deploying the solution comprises:
processing a communication plan;
verifying that the solution is installed;
testing the solution in a production environment;
performing a quick fix if the testing fails and the quick fix is available; and
restoring the original service if the testing fails and a quick fix is unavailable.

8. The programmable apparatus of claim 7 further comprising reevaluating the problem if the testing fails and a quick fix is unavailable.

9. The programmable apparatus of claim 8 wherein reevaluating the problem comprises:
determining what action is required to correct the failure;
preparing time and manpower estimates for the action; and
requesting approval from management for the action.

10. The programmable apparatus of claim 1 wherein monitoring the deployed solution comprises:
identifying an issue;
performing a quick fix if the quick fix is available for the issue; and
restoring the original process if the quick fix is unavailable.

11. The programmable apparatus of claim 1 wherein:
identifying the problem comprises
processing a problem identification form to evaluate the service,
identifying a core process from the problem identification form, and
processing an interface form to evaluate the interface between the core process and associated services;
processing the problem identification form comprises
processing a first worksheet to evaluate project office data associated with the service,
processing a second worksheet to evaluate processes and procedures associated with the service, and
processing a third worksheet to evaluate the technology associated with the service;
processing for the audit comprises
processing documents associated with the service,
processing an audit questionnaire,
processing approval of the audit questionnaire and the identified core process from management, and
sending audit notices to a delivery team;
performing the audit comprises
executing the core process and
evaluating the core process in accordance with the problem identification form, the interface form, and the audit questionnaire;
developing an action plan comprises
identifying discrepancies between the core process and associated procedures and tools,
resolving the discrepancies, and
establishing exit criteria;
deploying the solution comprises
releasing a communication plan,
verifying that the solution is installed,
testing the solution in a production environment,
performing a quick fix if the testing fails and the quick fix is available, and
restoring the original service if the testing fails and a quick fix is unavailable; and
monitoring the deployed solution comprises
identifying an issue,
performing a quick fix if the quick fix is available for the issue, and
restoring the original process if the quick fix is unavailable.

12. A programmable apparatus for evaluating the capacity of a distributed processing business system to provide a prospective service, the programmable apparatus comprising:
identifying the problem;
preparing for an audit;
performing the audit;
reviewing the audit;
preparing a rating table;
populating the rating table with results from the audit;
calculating a service rating based upon the results entered in the rating table; and
presenting the service rating to management.

13. The programmable apparatus of claim 12 further comprising:
developing an action plan for providing the prospective service;
developing an execution plan for deploying the prospective service;
deploying a service in accordance with the execution plan;
monitoring the deployed service; and
recording lessons learned.

14. A computer program product for analyzing a problem in a distributed processing business system used to provide a service, the computer readable memory comprising:
a computer readable storage medium;
a computer program stored in the computer readable storage medium;
the computer readable storage medium, so configured by the computer program, is adapted to cause a computer to perform steps comprising:
identifying the problem;
processing an audit;
reviewing the audit;
processing an action plan;
processing an execution plan;
deploying a solution in accordance with the execution plan;
monitoring the deployed solution; and
recording lessons learned.
